(19) United States
(12) Patent Application Publication
(10) Pub. No.: US 2012/0221687 A1
(43) Pub. Date: Aug. 30, 2012

(54) Systems, Methods and Apparatus for Providing a Geotagged Media Experience

(75) Inventors: Russell A. Hunter, Brooklyn, NY (US); Scott Lindenbaum, Brooklyn, NY (US)

(73) Assignee: BROADCASTR, INC., Brooklyn, NY (US)

(21) Appl. No.: 13/406,485

(22) Filed: Feb. 27, 2012

Related U.S. Application Data
(60) Provisional application No. 61/447,093, filed on Feb. 27, 2011.

(51) Int. Cl. G06F 15/16

(52) U.S. Cl. 709/219

(57) ABSTRACT

Systems, apparatus, methods and articles of manufacture provide for providing geotagged media files to a user based on one or more preferences associated with a user (e.g., criteria derived for and/or specified by the user), at least one recommendation for the user and/or a location of the user.

### CROSS-REFERENCE TO RELATED APPLICATIONS

The present application claims the benefit of priority of U.S. Provisional Patent Application No. 61/447,093, filed Feb. 27, 2011, and entitled “SYSTEMS, METHODS AND APPARATUS FOR PROVIDING A GEOTAGGED MEDIA EXPERIENCE,” which is incorporated by reference in this disclosure.

### BRIEF DESCRIPTION OF THE DRAWINGS

An understanding of embodiments described in this disclosure and many of the attendant advantages may be readily obtained by reference to the following detailed description when considered with the accompanying drawings, wherein:

FIG. 1A is a diagram of a system according to some embodiments of the present invention;

FIG. 1B is a diagram of a media experience system according to some embodiments of the present invention;

FIG. 2 is a diagram of a computer system according to some embodiments of the present invention;

FIG. 3 is a diagram of a database according to some embodiments of the present invention;

FIG. 4 is a flowchart of a method according to some embodiments of the present invention;

FIG. 5 is a flowchart of a method according to some embodiments of the present invention;

FIG. 6 is a flowchart of a method according to some embodiments of the present invention;

FIG. 7 is a flowchart of a method according to some embodiments of the present invention;

FIG. 8A depicts an example user interface according to some embodiments of the present invention;

FIG. 8B depicts an example user interface according to some embodiments of the present invention;

FIG. 9 depicts an example user interface according to some embodiments of the present invention;

FIG. 10 depicts an example user interface according to some embodiments of the present invention;

FIG. 11 depicts an example user interface according to some embodiments of the present invention;

FIG. 12 depicts an example user interface according to some embodiments of the present invention;

FIG. 13A depicts an example user interface according to some embodiments of the present invention;

FIG. 13B depicts an example user interface according to some embodiments of the present invention;

FIG. 13C depicts an example user interface according to some embodiments of the present invention;

FIG. 14 depicts an example user interface according to some embodiments of the present invention;

FIG. 15 depicts an example user interface according to some embodiments of the present invention;

FIG. 16 depicts an example user interface according to some embodiments of the present invention;

FIG. 17 depicts an example user interface according to some embodiments of the present invention;

FIG. 18 depicts an example user interface according to some embodiments of the present invention;

FIG. 19 depicts an example user interface according to some embodiments of the present invention;

FIG. 20 depicts an example user interface according to some embodiments of the present invention;

FIG. 21 depicts an example user interface according to some embodiments of the present invention;

FIG. 22 depicts an example user interface according to some embodiments of the present invention;

FIG. 23 depicts an example user interface according to some embodiments of the present invention;

FIG. 24 depicts an example user interface according to some embodiments of the present invention;

FIG. 25A depicts an example user interface according to some embodiments of the present invention;

FIG. 25B depicts an example user interface according to some embodiments of the present invention;

FIG. 26A depicts an example user interface according to some embodiments of the present invention;

FIG. 26B depicts an example user interface according to some embodiments of the present invention;

FIG. 26C depicts an example user interface according to some embodiments of the present invention;

FIG. 27A depicts an example user interface according to some embodiments of the present invention;

FIG. 27B depicts an example user interface according to some embodiments of the present invention; and

FIG. 28 depicts an example user interface according to some embodiments of the present invention.

### DETAILED DESCRIPTION

### A. Introduction

Applicants have recognized that, in accordance with some embodiments described in this disclosure, some users of mobile devices, including but not limited to mobile telephones, cellular telephones, GPS navigation devices, smart phones such as a BLACKBERRY, PALM, WINDOWS 7, IPHONE, or DROID phone, tablet computers such as an IPAD by APPLE, SLATE by HP, IDEAPAD by LENOVO, or XOOM by MOTOROLA, and other types of handheld, wearable and/or portable computing devices, may find it beneficial to be provided with a media experience based, at least in part, on media files that are associated with one or more physical locations (e.g., audio and/or video files that are geotagged with GPS or other location information).

Types of computing devices other than mobile devices are discussed in this disclosure, and still others suitable for various embodiments will be apparent to those of ordinary skill in light of this disclosure. Some users of other types of computing devices (e.g., desktop computers, kiosks) may also find similarly beneficial the functionality provided in accordance with some disclosed embodiments. Some types of providers of media files (e.g., television and radio networks, video and audio file providers, advertisement providers) may find it advantageous to be able to provide and/or contribute to a media experience for users that is based, at least in part, on media files associated with one or more physical locations.

It should be understood that the embodiments described in this disclosure are not limited to use with mobile devices, mobile client applications, desktop computers, or desktop client applications (although some embodiments may be described mainly with reference to such devices and applications, for ease of understanding), but are equally applicable to any computing device deemed desirable for a particular implementation. Any reference to a “mobile device” or “desktop computer” herein should be understood to equally refer to any such computing device, as appropriate.

In accordance with one or more embodiments, systems, apparatus, methods and articles of manufacture facilitate presenting, to a user, an augmented reality experience comprising audio, visual, textual, and/or haptic output via the user's mobile device (e.g., a smartphone) that changes (e.g., that suggests and/or presents different signals, information and/or media files) based on the user's location, speed, orientation, ambient light level, and/or altitude in real world, physical space. In one example, a user may view video content that is relevant to his or her current location, such as historical information or entertainment programming specific to the user's physical context. In another example, a user's real world experience at his or her current location may be enhanced by listening (e.g., via a speaker of a mobile device) to sounds, stories, music, educational information or other types of audio content collected and geotagged to facilitate playback based on the user's location. In another example, a user might view informational text and/or images pertinent to his or her location. In another example, a user may view (e.g., via a display of a mobile device) geotagged visual information (e.g., images, video or text) that layers over or otherwise enhances a video feed (e.g., captured by the camera of the mobile device) of the user's present location. In another example, a user may be presented with one or more other types of signals (e.g., via haptic output devices) geotagged in association with the user's location to provide an enhanced experience. Accordingly, some embodiments may provide an immersive and/or enhanced sensory, educational or entertainment experience to a user of a mobile device, augmenting the user's real world, physical experience at a given location.

In accordance with one or more embodiments, systems, apparatus, methods and articles of manufacture facilitate the delivery of contextually-relevant media content to a user (e.g., via a user's mobile device) based on his or her location, profile, preferences and/or detectable attributes or conditions such as speed, direction and/or compass orientation. In one sense, a user's movement through the real world informs a search query for content that the user is likely to consider relevant or of interest. Relevant or recommended media files may be determined based on a user's past consumption patterns (e.g., what types of files the user has listened to, read or watched), interests expressed directly to a central media service (e.g., by selecting a category of interest, such as architecture or history) and/or indirectly (e.g., based on the user linking to a social networking profile that lists architecture as an interest) and physical or environmental criteria (as detected or otherwise determined by a mobile device and/or server computer), such as the direction and speed of their movement, or whether the mobile device is in a pocket (e.g., based on light detected by a device's light sensor), etc.

In accordance with one or more embodiments, a media file might have metadata or be otherwise associated with information (e.g., stored in a database) which affects (e.g., based on one or more rules, algorithms and/or criteria) whether or not the file is added to a playlist generated for the user. In one example, a file may be locked or otherwise not available for playback to a user unless the user is within a certain distance of the file's associated location (e.g., a database record for the media file may indicate that it is only available for play if the user is within ten feet of the item's location). In another example, a file may be unlocked only for certain users (e.g., a database record for the media file may indicate that it is only available for playback to users identified as friends of the creator or contributor of the file). In another example, a file may be relevant temporally only at some predetermined time(s) (e.g., a database record for a media file may indicate that it is only available for play (unlocked) at midnight). It will be readily understood that a media file may be determined to be locked (available for playback) or unlocked (not available for playback) with respect to one or more particular users, based on any combination of factors related to user location, time and/or the respective user(s).

According to some embodiments, a user must be within a predetermined radius of a location associated with a media file in order to consume that media file (e.g., in order to have the file available for playback). In some embodiments, the predetermined radius may be established generally or by default (e.g., for all items). In some embodiments, a media item may be associated with a playback radius that differs from the playback radius associated with a different media item (e.g., even for the same associated location). The radius may be determined automatically by the system (e.g., by default and/or based on one or more factors such as type of media, location, file category, type of user (e.g., basic vs. premium subscriber), etc.) and/or an author or contributor of a file may specify a particular radius, or set of associated radii (e.g., one radius for followers, another radius for all other users). In some embodiments, a media file may be considered locked unless a user is within the predetermined radius (e.g., 150 feet), and then unlocked (and available for playback) once the user is within the predetermined radius. In some embodiments, a user cannot view or receive information about files that are locked; in other embodiments, a user can view information about a locked item but the item is not available for the user to play. In one example, a statue “whispers” only to those users within a ten foot radius. In another example, a band or other artist dedicates a media file to a city, and the media file is available for playback only within predefined area (e.g., the city radius), and/or only to users “following” a band on a social networking site.

According to some embodiments, items may be associated with particular times during which playback is available, in a manner similar to how files may be locked or unlocked based on the user's location relative to the location associated with the file. In one example, a file may be available for playback only during daytime, during particular hours or during one or more particular days (e.g., a holiday or specific date). As discussed above with respect to location-based locking, one or more different periods during which playback is available may be associated with one or more media files by the system and/or by individual users, creators or contributors, based on a variety of factors.

In some embodiments, a second media file may be locked (or otherwise unavailable to one or more users) until a first media file is unlocked and/or played (by one or more users). In one example, a creator of a tour may require that play of a second file at a first location is not available until a user first listens to a first file associated with that tour. In another example, a “scavenger hunt” or “race” format requires that a user first go to the location of and/or consume a first media file (e.g., at a first location) before unlocking and/or indicating a second media file (e.g., which may be at a second location that is different than the first location).

In accordance with one or more embodiments, systems, apparatus, methods and articles of manufacture provide for determining a location of a user (e.g., determining a location of a user device associated with the user); determining at least one criterion associated with the user (e.g., determining a filter for use in selecting media files to distribute to, present to, or otherwise transmit to a user device, user interface and/or user); generating a media experience for the user based on the location of the user and the at least one criterion, the media experience comprising a plurality of media files. In one example, a system generates for a user a playlist of geotagged audio files and/or video files based on the user's media preferences (e.g., stored in a user database). These preferences may be input by the user, imported from one or more of the user's social networking profiles (e.g., a user profile for a social network such as Facebook™ or LinkedIn™), and/or determined by reviewing user behavior patterns on the system. In some embodiments, playlists may be automatically generated by the application based on the user's location and/or stored preferences, and/or they may be curated by other users of the service, e.g. in the case of a guided tour, or a structured, narrative augmented reality experience.

In accordance with one or more embodiments, systems, apparatus, methods and articles of manufacture provide for automatic selection, delivery and/or playback of media files to a user based on the user's location and one or more criteria including, without limitation, preferences set by the user, preferences gleaned from user patterns (e.g., based on previous behavior on the service), preference gleaned from other user data (e.g. social networks, such as a user's profile on the Facebook™ social network), the direction the user is facing, the ambient light level (e.g., as detected by the user's device and used as an indication of whether the device is indoors or outdoors, is being held by the user, or is stowed in a pocket or bag (if no or little light is detected)), the speed and acceleration of the user, the device the user is running the application on, etc.

In accordance with one or more embodiments, systems, apparatus, methods and articles of manufacture provide for determining a first media file associated with a first ranking for a user and associated with a first location; determining a second media file associated with a second ranking for the user and associated with a second location; and generating a map interface based on the first media file and the second media file. In one example, two audio files are identified by a system for managing delivery of geotagged audio files, each audio file having a respective ranking determined for a user (e.g., based on the user's preferences, the quality of the item as determined by the interactions (liking, sharing, commenting) of other users with said item, and/or current location). According to the example, the system then provides (e.g., to the user's smartphone, to the user's tablet computer) an interactive map (e.g., using a map application, such as GOOGLE MAPS) having a coverage area configured to encompass both of the respective locations associated with the audio files.

In accordance with one or more embodiments, systems, apparatus, methods and articles of manufacture provide for determining a collection of media files, displaying one or more of the media files via an interactive map and/or a gallery (browse) view, and/or playing back one or more media files of the collection of media files automatically based on the user's location and movement (e.g., without input from the user).

In accordance with one or more embodiments, systems, apparatus, methods and articles of manufacture provide for determining a criterion associated with a user (e.g., a preference of a user for a particular type of file); determining a plurality of available media files (e.g., based on the criterion); determining a first location of a user device associated with the user; determining a first playlist based on the plurality of available media files, the criterion, the first location, a respective ranking of each media file, and/or a respective associated location for each media file; initiating play of a media file of the first playlist (e.g., the first media file listed in the first playlist); determining a second location of the user device that is different than the first location; determining a second playlist based on the plurality of available media files, the criterion, the second location, a respective ranking or rating of each media filing, and a respective associated location for each media file; and initiating play of a media file of the second playlist (e.g., the first media file listed in the second playlist). In one example, a software application (e.g., a mobile application) generates or receives a first playlist of audio and/or video files based on one or more preferences of the user and the current location of the user. As the user moves (e.g., walks or drives) and changes location, the application refreshes or updates the playlist based on the new location and the preferences.

In accordance with one or more embodiments, systems, apparatus, methods and articles of manufacture provide for determining, for each of a first plurality of media files, a respective rank (e.g., based on a score) of the media file; determining a first media file having a first rank that is greater than a predetermined rank; determining a second media file having a second rank that is not greater than the predetermined rank; generating an interface comprising a first representation of the first media file mapped to a first location on a first map having a first coverage area; receiving input of a user to modify the first map; and updating the interface to comprise the first representation of the first media file mapped to the first location on a second map having a second coverage area and to comprise a second representation of the second media file mapped to a second location on the second map.

### B. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting.

As used herein, “computing device” may refer to, without limitation, one or more personal computers, laptop computers, set-top boxes, cable boxes, network storage devices, media servers, automatic teller machines (ATM), kiosks, personal media devices, communications devices, display devices, financial transaction systems, vehicle or dashboard computer systems, televisions, stereo systems, video gaming systems, gaming consoles, cameras, video cameras, MP3 players, mobile devices, mobile telephones, cellular telephones, GPS navigation devices, smart phones, tablet computers, portable video players, satellite media players, satellite telephones, wireless communications devices, personal digital assistants (PDA) and point of sale (POS) terminals.

As used herein, “geotag” and “geotagging” may refer to the adding of geographical metadata, or other geographical identifier(s) identifying a geographical location, to various types of media such as, without limitation, audio, text files, pictures, video, SMS messages, MMS messages, RSS feeds, and the like. As used herein, geotag and geotagging may also refer to the storing of a file, or an identifier that identifies a file, in association with one or more geographical identifiers (e.g., in a database). In one example, a geotag or geographical metadata or geographical identifier(s) for a particular media file may comprise a latitude coordinate and a longitude coordinate. In another example, a geotag may comprise, alternatively or in addition, one or more of an altitude, bearing, distance, accuracy data and/or place name(s) (e.g., Times Square; Eiffel Tower). A geographical position may be derived, for example, from the global positioning system (GPS), and based on a latitude/longitude-coordinate system that presents each location on the earth from 180° west through 180° east along the Equator and 90° north through 90° south along the prime meridian. GPS coordinates may be represented in various ways, including as decimal degrees with negative numbers for south and west (e.g., 45.6789, -12.3456), degrees and decimal minutes and/or degrees, minutes and seconds. Applications and systems utilizing geotagging can help users and systems identify a wide variety of location-specific information. For instance, a user may be able to find images or audio files recorded near, or otherwise relevant to, a given location by entering the location's latitude and longitude coordinates into an appropriately configured search engine that will search for files (e.g., stored in one or more databases) with latitude and longitude coordinates near the entered coordinates. A file's coordinates may be stored, for example, in metadata of the file itself and/or otherwise in association with the file (e.g., in a database record). Geotagging-enabled information services can also be used to find location-based news, websites, or other resources.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

### C. General Systems and Structures

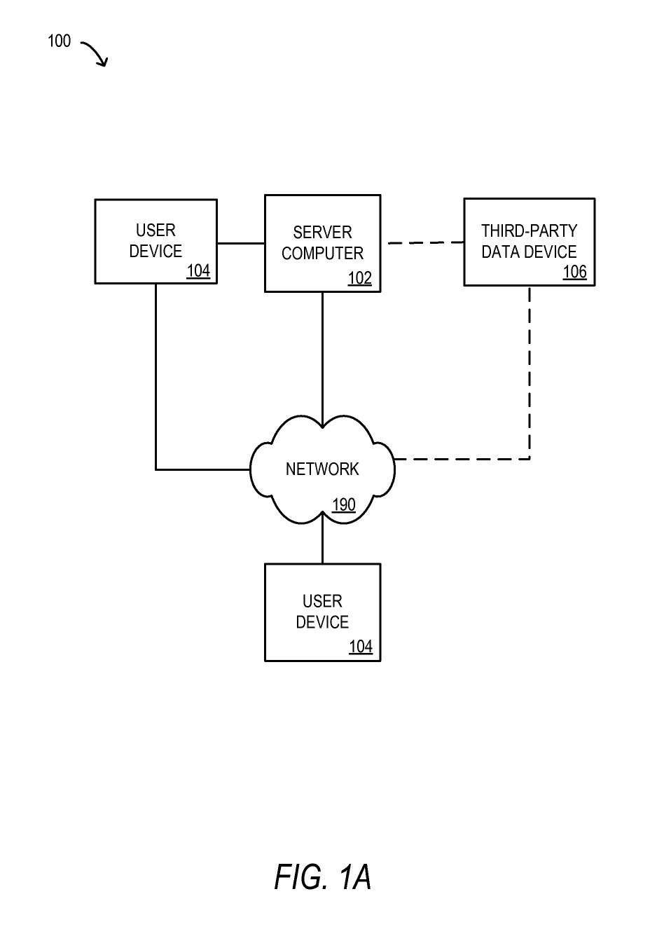

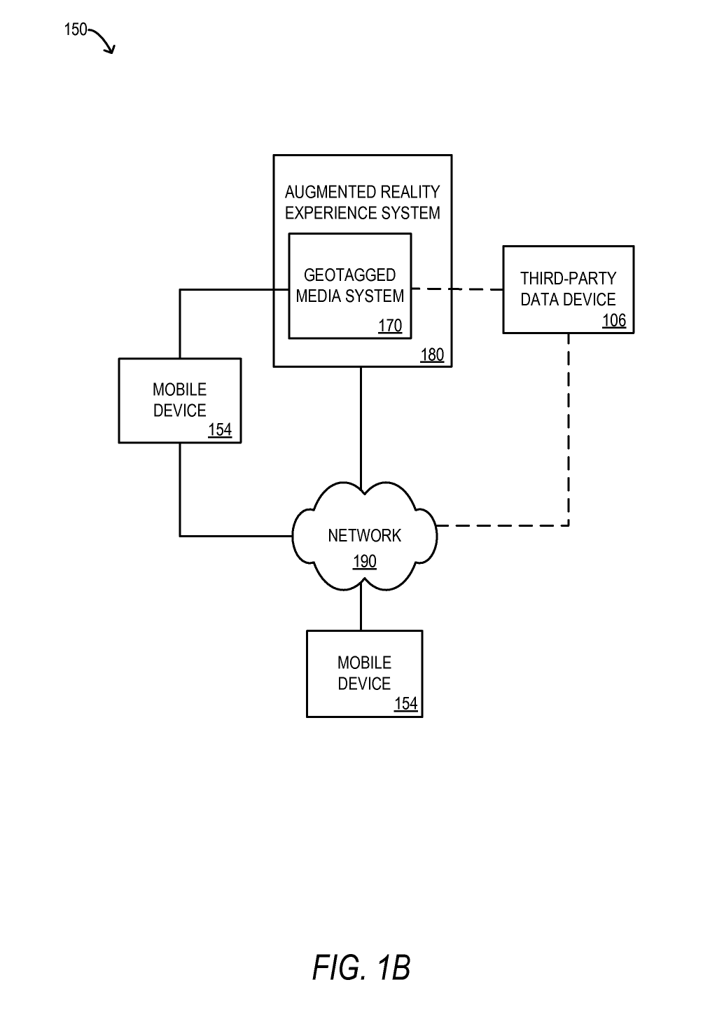

FIG. 1A depicts a block diagram of an example system 100 according to some embodiments. The system 100 may comprise one or more user devices 104 in communication with a controller or server computer 102 via a network 190. Typically a processor (e.g., one or more microprocessors, one or more microcontrollers, one or more digital signal processors) of a user device 104 or server computer 102 will receive instructions (e.g., from a memory or like device), and execute those instructions, thereby performing one or more processes defined by those instructions. Instructions may be embodied in, e.g., one or more computer programs and/or one or more scripts.

In some embodiments a server computer 102 and/or one or more of the user devices 104 stores and/or has access to data useful for managing and distributing files and other content (e.g., geotagged audio files). Such information may include one or more of: (i) user data and (ii) media file data.

According to some embodiments, any or all of such data may be stored by or provided via one or more optional third-party data devices 106 of system 100. A third-party data device 106 may comprise, for example, an external hard drive or flash drive connected to a server computer 102, a remote third-party computer system for storing and serving data for use in generating and/or presenting maps, recommending media files for one or more users or selecting and/or presenting advertising, or a combination of such remote and local data devices. A third-party entity (e.g., a party other than an owner and/or operator, etc., of the server computer 102, user device 104 and other than an end-user of any interface or media file) such as a third-party vendor collecting data on behalf of the owner, a marketing firm, government agency and/or regulatory body, and/or demographic data gathering and/or processing firm may, for example, monitor user preferences, selections, actions via one or more interfaces for various purposes deemed useful by the third-party, including data mining, data analysis, and price tracking, and any raw data and/or metrics may be stored on and/or via the third-party data device 106. In one embodiment, one or more companies and/or end users may subscribe to or otherwise purchase data (e.g., user histories of media plays) from a third party and receive the data via the third-party data device 106.

In some embodiments, a user device 104, such as a computer workstation, mobile phone, or kiosk, is used to execute an application for geotagged media files, stored locally on the user device 104, that accesses information stored on, or provided via, the server computer 102. In another embodiment, the server computer 102 may store some or all of the program instructions for distributing geotagged media files, and the user device 104 may execute the application remotely via the network 190 and/or download from the server computer 102 (e.g., a web server) some or all of the program code for executing one or more of the various functions described in this disclosure.

In one embodiment, a server computer may not be necessary or desirable. For example, some embodiments described in this disclosure may be practiced on one or more devices without a central authority. In such an embodiment, any functions described herein as performed by a server computer and/or data described as stored on a server computer may instead be performed by or stored on one or more such devices. Additional ways of distributing information and program instructions among one or more user devices 104 and/or server computers 102 will be readily understood by one skilled in the art upon contemplation of the present disclosure.

FIG. 1B depicts a block diagram of another example system 150 according to some embodiments. The system 150 may comprise one or more mobile devices 154 in communication with an augmented reality experience system 180 (such as may be hosted by, for example, a server computer 102) via a network 190. A geotagged media system 170 is integrated into the augmented reality experience system 180, for example, as a module or other functionality accessible through the augmented reality experience system 180. In one embodiment, information about a particular augmented reality experience stored by the augmented reality experience system 180 may be provided advantageously to the geotagged media system 170. For example, stored information about a user, such as present location and/or one or more preferences for enhanced or supplemental content, may be accessible by the geotagged media system 170. As discussed above with respect to system 100 of FIG. 1A, in some embodiments one or more third-party data devices 106 may store information (e.g., advertising offers, mapping information) used in creating a media experience (or multimedia experience) for a user of a user device.

In some embodiments, a mobile device 154 may comprise a mobile or portable computing device such as a smart phone (e.g., the IPHONE manufactured by APPLE, the BLACKBERRY manufactured by RESEARCH IN MOTION, the PRE manufactured by PALM or the DROID manufactured by MOTOROLA), a Personal Digital Assistant (PDA), cellular telephone, laptop or other portable computing device and an application for providing access to geotagged media files is stored locally on the mobile device 154, which may access information (e.g., media files, recommendations of media files for users, user data and/or map data) stored on, or provided via, the augmented reality experience system 180 and/or geotagged media system 170. In another embodiment, the geotagged media file system 170 may store some or all of the program instructions for providing access to geotagged media files, and the mobile device 154 may execute the application remotely via the network 290 and/or download from the geotagged media system 170 (e.g., a web server) some or all of the program code for executing one or more of the various functions described in this disclosure.

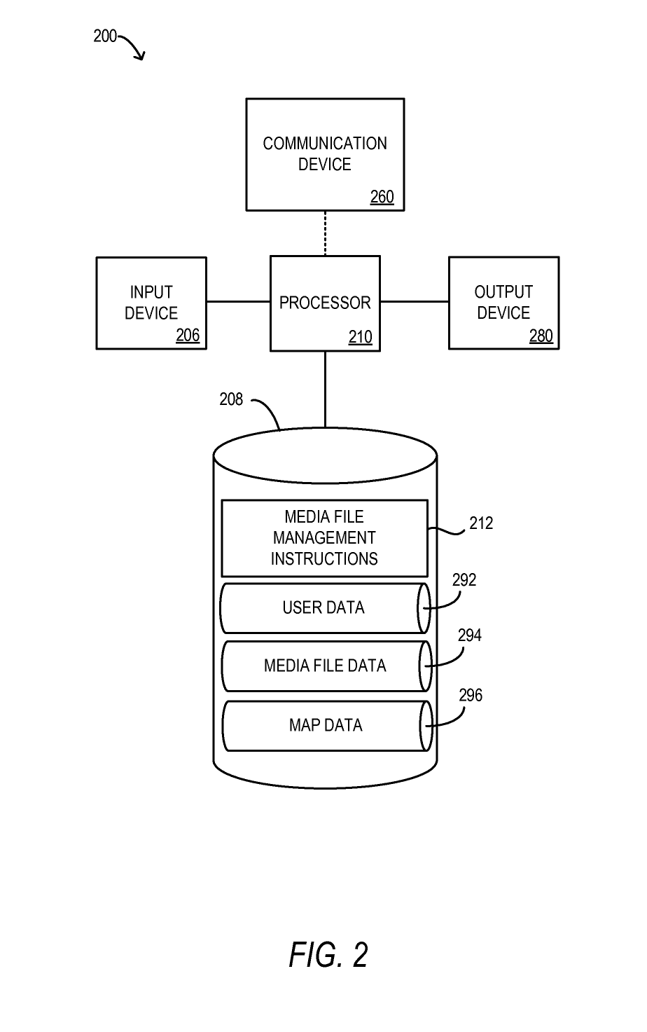

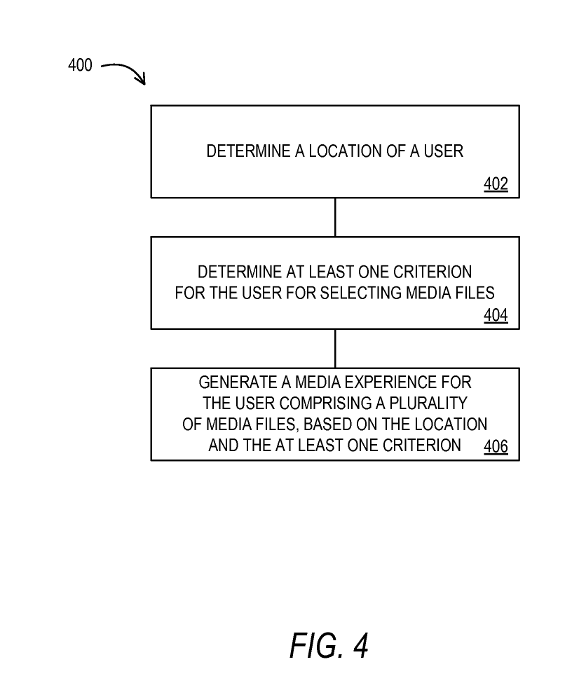

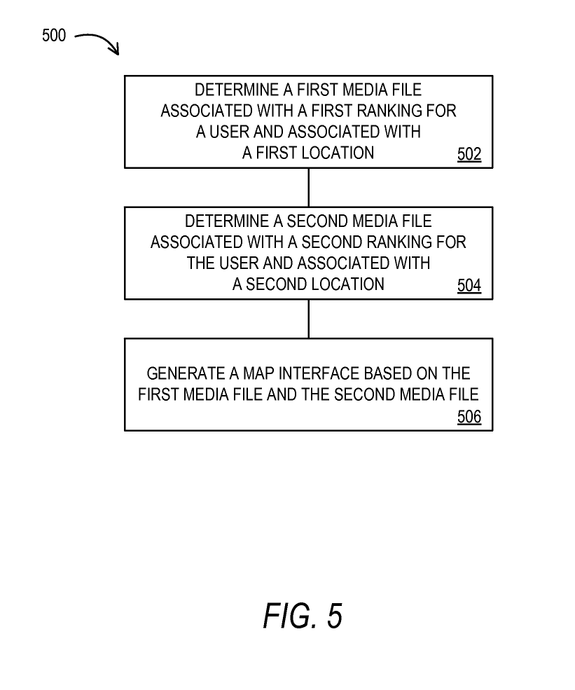

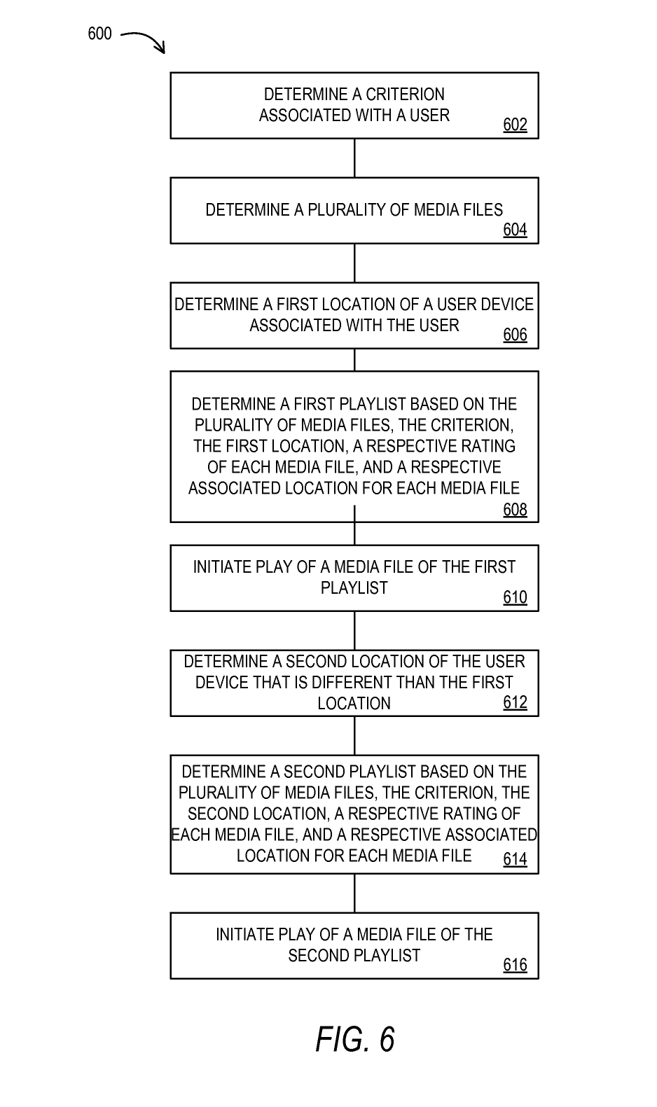

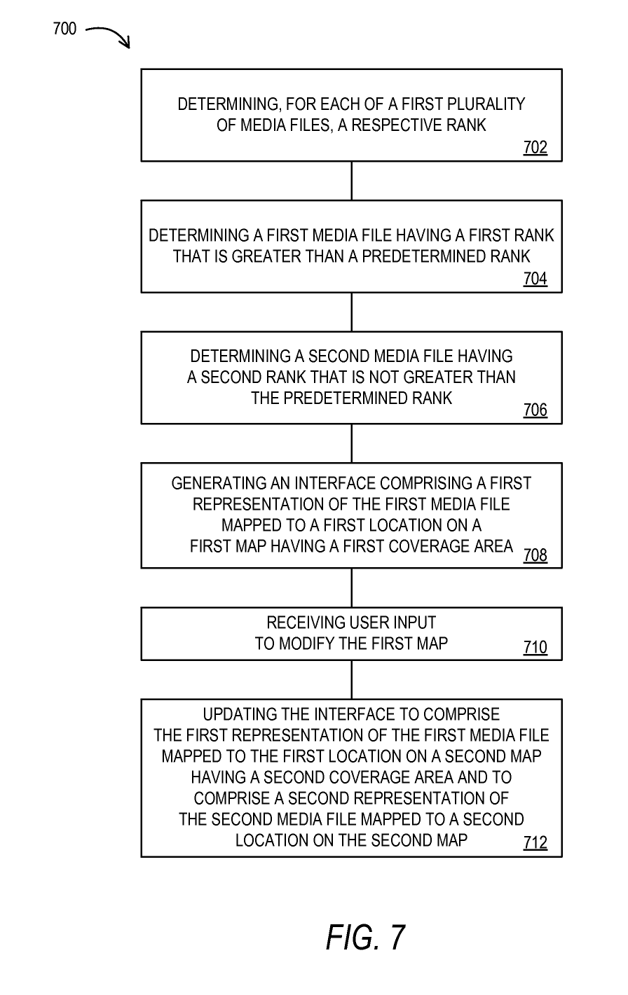

Turning to FIG. 2, a block diagram of an apparatus 200 according to some embodiments is shown. In some embodiments, the apparatus 200 may be similar in configuration and/or functionality to any of the user devices 104, mobile devices 154, server computers 102 and/or third-party data devices 106 of FIG. 1A and/or FIG. 1B. The apparatus 200 may, for example, execute, process, facilitate, and/or otherwise be associated with any of the processes 400, 500, 600, 700 described in conjunction with FIG. 4, FIG. 5, FIG. 6 and FIG. 7 in this disclosure.

In some embodiments, the apparatus 200 may comprise an input device 206, a memory device 208, a processor 210, a communication device 260, and/or an output device 280. Fewer or more components and/or various configurations of the components 206, 208, 210, 260, 280 may be included in the apparatus 200 without deviating from the scope of embodiments described herein.

According to some embodiments, the processor 210 may be or include any type, quantity, and/or configuration of processor that is or becomes known. The processor 210 may comprise, for example, an Intel® IXP 2800 network processor or an Intel® XEON™ Processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 200 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a keyboard that allows an operator of the apparatus 200 to interface with the apparatus 200 (e.g., by a phone user, such as to dial a call or send an email). The input device 206 may comprise, for example, a camera and/or a headphone jack. Input device 206 may include one or more of a key, touch screen, or other suitable tactile input device. Input device 206 may include a microphone comprising a transducer adapted to provide audible input of a signal that may be transmitted (e.g., to the processor 210 via an appropriate communications link). In some embodiments, the input device 206 may comprise an accelerometer, gyroscope, compass or other device configured to detect movement, tilt and for orientation (e.g., portrait or landscape view of a smartphone) of the device, such as a three-axis digital accelerometer (e.g., ADXL345 by Analog Devices, Inc., 8134 33DH 00D35 by STMicroelectronics, Inc.), the AGD8 2135 LUSDI vibrating structure gyroscope by STMicroelectronics, Inc., or AK8973 electronic compass by AKM Semiconductor, Inc. As will be readily understood by those of skill in the art, signals from integrated and/or external accelerometers, gyroscopes and/or compasses may be used (alone or in combination) to calculate orientation, tilt and/or direction of a device (e.g., a mobile phone). In some embodiments, the input device 206 may comprise a barometer and/or light meter, such as may be integrated in a camera chip for a mobile device. Accordingly to some embodiments, the level of ambient light may be used (e.g., according to program instructions processed by a device processor) to determine a ranking for one or more available media files based on one or more rules. In one example, a signal from a light meter indicating no or relatively low light may be interpreted (e.g., according to rules implemented for a particular desirable implementation) as an indication that it is nighttime, the device is indoors, and/or that the user device is stowed away (e.g., in a bag or pocket). In another example, a first media file may be ranked higher for a user than a second media file, based on the level of ambient light (e.g., where the detected light level is low, and the first media file is associated with an indoor location, and the second media file is associated with an outdoor location).

The output device 280 may, according to some embodiments, comprise a display screen and/or other practicable output component and/or device. Output device 280 may include one or more speakers comprising a transducer adapted to provide audible output based on a signal received (e.g., via processor 210).

According to some embodiments, the input device 206 and/or the output device 280 may comprise and/or be embodied in a single device such as a touch-screen display.

In some embodiments, the communication device 260 may comprise any type or configuration of communication device that is or becomes known or practicable. The communication device 260 may, for example, comprise a NIC, a telephonic device, a cellular network device, a router, a hub, a modem, and/or a communications port or cable. In some embodiments, the communication device 260 may be coupled to provide data to a telecommunications device. The communication device 260 may, for example, comprise a cellular telephone network transmission device that sends signals to a server in communication with a plurality of handheld, tablet, mobile and/or telephone devices. According to some embodiments, the communication device 260 may also or alternatively be coupled to the processor 210.

Communication device 260 may include, for example, a receiver and a transmitter configured to communicate via signals according to one or more suitable data and/or voice communication systems. In some embodiments, the communication device 260 may comprise an IR, RF, Bluetooth™ and/or Wi-Fi® network device coupled to facilitate communications between the processor 210 and another device (such as one or more mobile devices, server computers, central controllers and/or third-party data devices). For example, communication device 260 may communicate voice and/or data over mobile telephone networks such as GSM, CDMA, CDMA2000, EDGE or UMTS. Alternately, or in addition, communication device 260 may include receiver/transmitters for data networks including, for example, any IEEE802.x network such as WiFi or Bluetooth™.

The memory device 208 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 208 may, according to some embodiments, store media file management instructions 212, user data 292, media file data 294 and/or map data 296. In some embodiments, the media file management instructions 212 may be utilized by the processor 210 to provide output information via the output device 280 and/or the communication device 260 (e.g., via the user interfaces 100 and/or 150 of FIG. 1A and FIG. 1B, respectively).

According to some embodiments, media file management instructions 212 may be operable to cause the processor 210 to process user data 292, media file data 294 and/or map data 296 as described herein.

Any or all of the exemplary instructions and data types described herein and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 (e.g., as shown) or may simply be accessible to the apparatus 200 (e.g., externally located and/or situated).

In some implementations, the apparatus 200 comprises a touch-sensitive display. The touch-sensitive display may be implemented with liquid crystal display (LCD) technology, light emitting polymer display (LPD) technology, or some other display technology. The touch-sensitive display can be sensitive to haptic and/or tactile contact with a user. In some embodiments, the touch-sensitive display may comprise a multi-touch-sensitive display that can, for example, process multiple simultaneous touch points, including processing data related to the pressure, degree, and/or position of each touch point. Such processing facilities gestures and interactions with multiple fingers, chording, and other interactions. Alternately or in addition, other touch-sensitive display technologies may be used, such as, without limitation, a display in which contact is made using a stylus or other pointing device.

In some embodiments, the apparatus 200 may be adapted to display one or more graphical user interfaces on a display (e.g., a touch-sensitive display) for providing the user access to various system objects and/or for conveying information to the user. Some examples of system objects include device functions, applications, windows, files, alerts, events, or other identifiable system objects.

In some embodiments, the apparatus 200 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the apparatus 200 (e.g., embodied as a mobile device) or provided as a separate device that can be coupled to the apparatus 200 through an interface (e.g., via communication device 260) to provide access to location-based services.

The memory device 208 may also store communication instructions to facilitate communicating with one or more additional devices, one or more computers and/or one or more servers. The memory device 208 may include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/Navigation instructions to facilitate GPS and navigation-related processes and instructions; camera instructions to facilitate camera-related processes and functions; audio command instructions and/or voice recognition instructions to facilitate processing and functions based on and/or in response to audio, verbal and/or voice input from a user; and/or other software instructions to facilitate other processes and functions. The memory device 208 may also store other software instructions, such as web video instructions to facilitate web video-related processes and functions; and/or web shopping instructions to facilitate web shopping-related processes and functions. In some embodiments, the media processing instructions may be divided into audio processing instructions and video processing instructions to facilitate audio processing-related processes and functions and video processing-related processes and functions, respectively.

### D. Databases

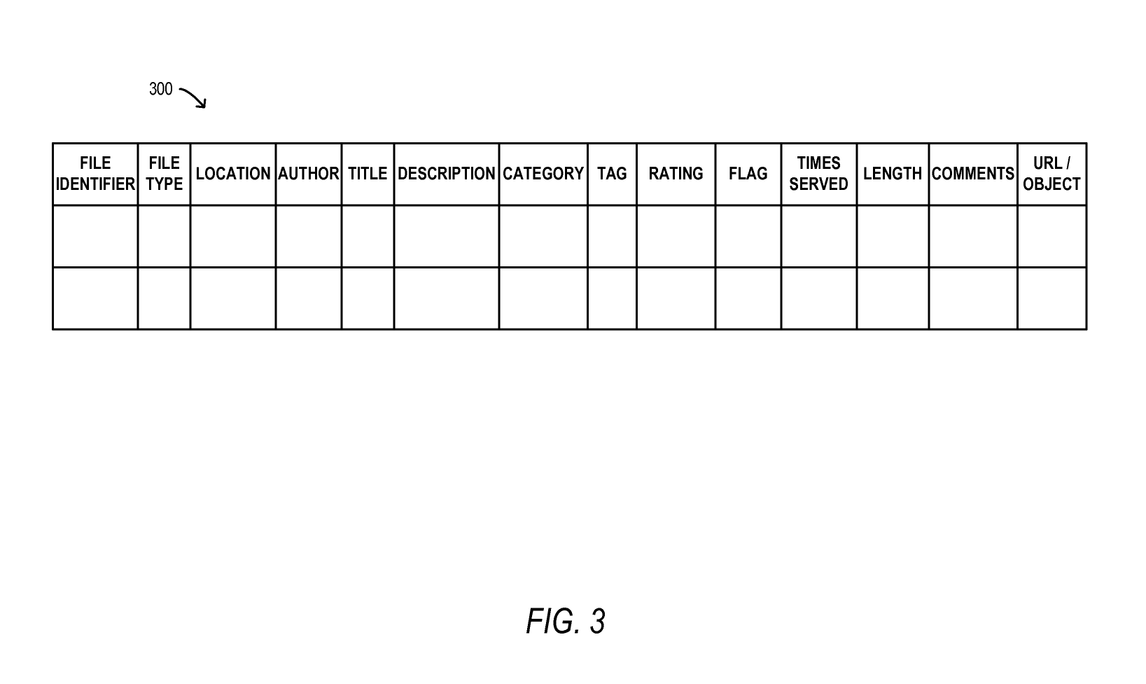

Referring to FIG. 3, a schematic illustration of an exemplary data structure 300 according to some embodiments is shown. In some embodiments, the exemplary data structure 300 may comprise a tabular representation illustrating an embodiment of the media file data 294. The exemplary data structure 300 that is representative of the media file data 294 includes a number of example records or entries, each of which defines data for a particular media file (e.g., recorded and/or transmitted via a mobile device and/or other computing device). Those skilled in the art will understand that the media file data 294 may include any number of entries.

The exemplary data structure 300 of the media file data 294 also defines fields for each of the entries or records, including: (i) a file identifier field that uniquely identifies the file (e.g., a filename), (ii) a file type field that identifies a type of the file (e.g., audio, MP3, WAV, video, MP4, picture, JPG), (iii) a location field that identifies one or more locations associated with the file (e.g., GPS coordinates, place names, street address), (iv) an author field that identifies an author or source of the file (e.g., a user name of a user that recorded and uploaded the file to a media file management system), (v) a title field that indicates a title of the file (e.g., for presenting via a user interface in search results), (vi) a description field that includes a text description and/or tagline associated with the file (e.g., a brief description of a story provided in the file), (vii) a category field that includes an indication of one or more categories associated with the file (e.g., History, Humor, Architecture) that may be used in some embodiments for searching, (viii) a tag field that includes an indication of one or more tags or keywords associated with the file (e.g., “cats,” “taxi”) that may be used in some embodiments for searching, (ix) a rating field that includes an indication of a rating of the file (e.g., an aggregate rating, such as a numeric or alphanumeric score based on individual ratings of the file provided by a plurality of users), (x) a flag field that includes an indication of whether the file has been flagged (e.g., as inappropriate and/or for removal), (xi) a times served field that includes an indication of a number of times the file has been served to users (e.g., a total number of times that users have listened to the file), (xii) a length field that includes an indication of the length of a media file (if appropriate for the type of file) (e.g., a duration in minutes of a geotagged audio file), (xiii) a comments field that includes an indication of one or more comments (e.g., by users) associated with the file (e.g., an identifier that uniquely identifies an entry in a comments database, the content of one or more text, video and/or audio comments/responses to a file) and (xiv) a URL/object field that includes an indication of a URL associated with the file (e.g., a public or private URL addressing a network location of a file) and/or a code or script for embedding the file as an object (e.g., in another file, in a website).

### E. Processes

Referring now to FIG. 4, a flow diagram of a method 400 according to some embodiments is shown. The method 400 will be described herein as being performed by a server computer (e.g., in communication with a mobile device such as a wireless or cellular phone). It should be noted that although some of the steps of method 400 may be described herein as being performed by a server computer while other steps are described herein as being performed by another computing device, any and all of the steps may be performed by a single computing device which may be a mobile device, server computer, third-party data device or another computing device. Further, any steps described herein as being performed by a particular computing device may be performed by a human or another computing device as appropriate.

According to some embodiments, the method 400 may comprise determining a location of a user, at 402. In one example, the location of the user may be determined by determining a GPS position of a user device (e.g., the user device may transmit its GPS position to a server computer).

The method 400 may comprise determining at least one criterion associated with the user, at 404 (e.g., determining a filter for use in selecting media files to distribute to, present to, or otherwise transmit to a user device, user interface and/or user). In one example, information about a user may be stored in a database (e.g., a user data 292). Such information may include, without limitation, an identifier that uniquely identifies a user and an indication of one or more media preferences of the user. For example, user data 292 may include an indication that a user listens most frequently to audio files having a category of “History.” In another example, user data 292 may include an indication that the user has provided input that he has a strong like for “Comedy” category items, is neutral on “Arts” category items and strongly dislikes “Architecture” category items.

The method 400 may comprise generating a media experience for the user based on the location of the user and the at least one criterion, the media experience comprising a plurality of media files, at 406. In one example, a system generates for a user a playlist of geotagged audio files and/or video files based on the user's preferences (e.g., stored in a user database), as may be explicitly indicated by a user and/or derived (e.g., by the server computer) based on information about the user's history and previous interactions with the system.

Referring now to FIG. 5, a flow diagram of a method 500 according to some embodiments is shown. The method 500 will be described herein as being performed by a mobile device (e.g., a wireless or cellular phone). It should be noted that although some of the steps of method 500 may be described herein as being performed by a mobile device while other steps are described herein as being performed by another computing device, any and all of the steps may be performed by a single computing device which may be a mobile device, server computer, third-party data device or another computing device. Further, any steps described herein as being performed by a particular computing device may be performed by a human or another computing device as appropriate.

According to some embodiments, the method 500 may comprise determining a first media file associated with a first ranking for a user and associated with a first location, at 502, and determining a second media file associated with a second ranking for the user and associated with a second location, at 504. In one example, two audio files are identified by a software application running on a mobile device for managing delivery of geotagged audio files, each audio file having a respective ranking determined for a user (e.g., based on the user's preferences and/or current location) and having a respective associated geographical identifier (e.g., GPS coordinates). For instance, the two media files may be included in search results based on a user's entering of search terms in a user interface to search for audio content relevant to the user's present location.

The method 500 may comprise generating a map interface based on the first media file and the second media file, at 506. In one example, the mobile device then provides (e.g., via a display) an interactive map (e.g., using a map application, such as GOOGLE MAPS) having a coverage area configured to encompass both of the respective locations associated with the audio files. For instance, the coverage area of the map may be determined so as to represent a physical area including the geographical positions associated with the first and second media files.

Referring now to FIG. 6, a flow diagram of a method 600 according to some embodiments is shown. For purposes of brevity, the method 600 will be described herein as being performed by a mobile device (e.g., a cell phone). It should be noted that although some of the steps of method 600 may be described herein as being performed by a mobile device while other steps are described herein as being performed by another computing device, any and all of the steps may be performed by a single computing device which may be a mobile device, server computer, third party data device or another computing device. Further, any steps described herein as being performed by a particular computing device may be performed by a human or another computing device as appropriate.

According to some embodiments, the method 600 may comprise determining a criterion associated with a user, at 602, and determining a plurality of media files, at 604. For example, a mobile device running a local application may request from and/or provide to a server computer an indication of a preference of a user (e.g., a content category derived with respect to and/or specified by the user) and/or a search term provided by the user. The mobile device and/or server computer may then search a database (e.g., media file data 294) using the one or more criteria, and receive an indication of a plurality of different media files.

In some embodiments, determining the plurality of media files may comprise determining a plurality of available media files. As discussed in this disclosure, one or more media files may be associated with one or more respective conditions for making the file available for playback to a user, such as a predetermined geographical playback radius, predetermined period of time and/or one or more predetermined users. The predetermined period of time may comprise any definable period of time, such as, without limitation, one or more specific times or ranges of time (e.g., “6:00 pm EST”, “5:00 am-10:00 am”, “2005 Feb. 15:0630”), days (e.g., “Saturday”) and/or dates (e.g., “2012”, “January”, “February 29”, “Nov. 24, 2006”).

Accordingly, in some embodiments, determining an available media file may comprise, for example, querying a database of potential media files (e.g., media file data 294), identifying at least one media file that is associated with at least one condition specified by a contributor of the at least one media file (e.g., a geographical playback restriction indicated in a record of media file data 294), determining that the at least one condition is satisfied (e.g., based on a user's location, based on the current time) and unlocking playback of the at least one media file for the user or otherwise identifying the media file as being available for a playlist and/or playback by the user.

In one example, determining available media files comprises determining at least one media file that is associated with a predetermined geographical radius for enabling playback, and determining that a user's location is within the predetermined geographical radius, and determining that the at least one media file is available to the user. For such media files, playback is not available to users who are outside of the respective, predetermined geographical radius for a given file; the files may be considered “locked” for users outside the radius. Although some examples may refer specifically to a “radius”, it will be readily understood that a geographical area in which playback is available may be defined in any of various manners (e.g., a ZIP code, a state, an area defined in any shape). In another example, determining available media files may comprise determining at least one media file that is associated with a predetermined period of time for enabling playback (e.g., playback of the file is not available to users outside of the predetermined period of time),determining that a current time (e.g., as determined by the server computer or the mobile device) is within the predetermined period of time or otherwise satisfies the time restriction, and determining that the at least one media file is available to the user. Similar types of conditions may be based on a predetermined set of one or more users who are eligible to receive a media file (e.g., a defined group of users, followers of a particular user).

The method 600 may comprise determining a first location of a user device associated with the user, at 606. Various ways of determining the location of a user device, such as a smartphone, will be readily understood by those of skill in the art (e.g., via a GPS receiver).

The method 600 may comprise determining a first playlist based on the plurality of media files, the first location, a respective ranking of each media file, and a respective associated location for each media file, at 608. In some embodiments, media files (e.g., audio files) may be associated (e.g., in a database such as media file data 294) with respective aggregate ratings and respective geographical locations (e.g., GPS coordinates). Alternatively, or in addition, a particular user's rating of a given media file may be stored.

According to some embodiments, generating a playlist may comprise sorting, ordering, determining respective numerical scores for, and/or ranking the plurality of media files (e.g., those that meet a user's search criteria) and/or selecting a subset of the plurality of media files (e.g., selecting the top twenty ranked files). The ranking may be based, in some embodiments, on one or more of (i) the aggregate ratings of the files, (ii) a user's individual ratings of the files, (iii) the user's location, (iv) the user's direction as determined by a compass in the mobile device, (v) whether the files are recommended (e.g., based on the similarity between the files and other content the user has listened to and/or rated), (vi) the associated location of the files (e.g., how close the file's geotag is located to the user's current location), (vii) the ambient light level (e.g., used to determine whether a phone is in hand or stowed in a pocket, whether it is day or night, and/or whether the user is inside or outside) and/or (viii) the speed of the user, as determined by the mobile device's accelerometer and/or the distance traversed by the user in-between queries. For example, a user travelling at 60 mph may be served media items drawing from a wider geographical radius than a user travelling at 1 mph. In another example, a user travelling in a determined direction may be served media items drawn from locations ahead of the user's direction of travel (e.g., within a predetermined range from the user's anticipated course), and the media items may, in some embodiments, also be based on the speed of travel, as discussed above. In some embodiments, each media file may be assigned a numerical score, or a playback order, based on a formula that assigns particular weights to each of the example criteria (i)-(viii). Other methods for ordering a playlist of media files and/or recommending, offering and/or presenting media files will be understood by those of skill in the art in light of the embodiments discussed in this disclosure.

The method 600 may comprise initiating play of a first media file of the first playlist, at 610. In one example, a mobile device application automatically initiates play of the first audio file in the generated playlist (e.g., via a player function and the speakers of the mobile device). In another example, the mobile device receives input from the user to begin play (e.g., the user touches a touch screen display to select an audio file for playback).

The method 600 may comprise determining a second location of the user device that is different than the first location, at 612, and determining a second playlist based on the plurality of media files, the second location, a respective ranking of each media filing, and a respective associated location for each media file, at 614. Accordingly, some embodiments may provide for generating a second playlist (e.g., a new playlist) based on a second location of the user (e.g., a new location after the user has moved). The method 600 may comprise initiating play of a second media file of the second playlist, at 616. Play of a media file is discussed above with respect to 610.

As described in this disclosure, some embodiments do not require determining a plurality of media files based on keywords, categories or other search criteria input or specifically indicated or indicated by a user. Alternatively, or in addition, a criterion associated with a user may comprise one or more criteria or preferences associated with a user implicitly and/or derived (e.g., by a controller device) based on behavior or other information about a user (e.g., subjects of media files a user previously had selected for playback, or posts a user has “Liked” or shared on Facebook).

As described in this disclosure, in some embodiments, a subset of available media files need not be determined based on a criterion, and then filtered further based on one or more additional factors (e.g., location). Alternatively, or in addition, a playlist may be generated based on a plurality of available media files (e.g., not necessarily based on a keyword or criterion associated with a user), and one or more of: a location, a respective ranking each available media file, a respective associated location for each media file, aggregate ratings of the files, a user's individual ratings of the files, the user's direction, an indication of ambient light level, the user's speed and/or whether the files are recommended.

In one example implementation, which may be referred to herein as a “Geoplay mode,” a software application (e.g., an application being executed by a processor of a mobile device) generates or receives a first playlist of media files based on one or more preferences (e.g., derived by the system and/or explicitly provided by the user) of the user and the current location of the user. As the user moves (e.g., walks or drives) and changes location, the application refreshes or updates the playlist based on the new location and the preferences. The playlist may change based on the user's location, providing, in accordance with some embodiments, an immersive or enhanced reality experience tied to the user's movement through the physical world, and directed to providing to the user the localized content the user is most likely to enjoy. As discussed in this disclosure, in some embodiments, the playlist may be based on one or more criteria such as (i) the user's search terms and/or (ii) preferences of the user (explicitly indicated and/or inferred by the system) for particular types of content. In some embodiments, the Geoplay mode may be toggled on and off.

In one example implementation, a user initiates Geoplay mode in order to be served a dynamically generated, relevant playlist of multimedia content that is specifically tailored to his or her location, interests and circumstances. In some embodiments, Geoplay may be initiated either manually (e.g., by the user tapping a button represented on the application's interface via the device's touchscreen display) or automatically (e.g., if the application is configured to initiate Geoplay upon startup). Initiating Geoplay mode generates a playlist request, which is sent by the user device to the server computer. In some embodiments, the playlist request includes the location of the user, any explicit preferences defined by the user and/or stored in the user record or profile (e.g., an interest in architecture). In some embodiments, in addition to or in place of the explicit preferences, inferred or derived preferences may be generated dynamically by the system (e.g., the software running on the user device and/or by the server computer). In one example, history of media files played back by the user indicates a preference for historical items.

Continuing with the example implementation, the playlist request preferably also includes one or more conditional, contextual and/or environmental attributes (e.g., the direction of the user (as determined by the internal compass on the user's device), the velocity of the user, the time of day, etc.).

The playlist request is then processed by the playlist service, which includes searching a database of available media items, each of which is associated with a respective location or “Geocell.” In one example, each media item is assigned to a map, which is divided into a grid of individual Geocells, and every media item is contained in a specific, numbered (or otherwise uniquely identified) Geocell. According to the example implementation, a rules engine applies one or more algorithms and/or conditional statements to the play list request made to the playlist service in order to generate or otherwise determine a dynamic playlist of media items customized and appropriate for the requesting user. In one example, items not in the direction of a user's travel, or “behind” a user geographically based on the user's indicated direction of travel, as determined based on input from a compass and/or GPS receiver, may be removed from an existing playlist and/or may otherwise not be made available in generating a playlist (e.g., automatically). For instance, a user leaving a graveyard and walking toward a church may be served media content related to the church, even if the user is geographically closer to the graveyard now behind him. In some embodiments, such items may still be indicated to a user (e.g., via a gallery view of nearby items, via a map interface), even if they are specifically not included in a generated playlist.

In one example, a user has expressed an explicit preference for Architecture (e.g., by selecting that category from a list of available categories) and has a current velocity of 60 mph, which indicates the user currently is driving. In response to a request for a playlist, generated by the software application running on the user's device and received by the server computer, the server computer searches the database of available media files and retrieves a playlist of items that are: (1) associated with the Architecture category, (2) have respective quality ratings of a high threshold (e.g., the top twenty rated files) and (3) are within five miles of the user. Accordingly, the server computer dynamically generates a playlist of the Architecture highlights of the city in which the user is driving. In another example, a second user with the same preference for Architecture is determined to be on foot, based on a detected velocity of the user device of 3 mph. After receiving the request, the server computer dynamically creates a playlist that provides an Architectural walking tour of the user's immediate surroundings by selecting Architecture items that are within a smaller geographical radius and exceed a lower rating threshold than that used for the first user, to ensure that a sufficient number of items within the smaller radius are served.

In some embodiments, one or more additional factors (e.g., such as conditional attributes, items specially “Featured” on the media service platform, items created by users “Followed” by the current user, etc) may be used to influence further playlist generation, resulting in a customized, tailored experience for each user.

Referring now to FIG. 7, a flow diagram of a method 700 according to some embodiments is shown. It should be noted that although some of the steps of method 700 may be described herein as being performed by a mobile device while other steps are described herein as being performed by another computing device, any and all of the steps may be performed by a single computing device which may be a client computer, server computer, third party data device or another computing device. Further, any steps described herein as being performed by a particular computing device may be performed by a human or another computing device as appropriate.

According to some embodiments, the method 700 may comprise determining, for each of a first plurality of media files, a respective rank (e.g., based on a score), at 702. Various ways of determining a respective rank for a media file are discussed with respect to method 600 and elsewhere in this disclosure.

The method 700 may comprise determining a first media file having a first rank that is greater than a predetermined rank, at 704, and determining a second media file having a second rank that is not greater than the predetermined rank, at 706. In one example, where identification of the top twenty-five ranked media files is desired, with “1” being the highest rank, the predetermined rank may be “26”.

The method 700 may comprise generating an interface comprising a first representation of the first media file mapped to a first location on a first map having a first coverage area, at 708. In one embodiment, the second media file is not represented on the first map (e.g., its rank is too low to appear on the map). In one example, using map data 296, a mobile application generates a map view (e.g., of the New York City metro area) via the display of a smartphone. The map view includes a “thumbnail” photo, “pin”, icon or other indicia to represent the first media file (e.g., an audio story about an experience at the Museum of Natural History) at its corresponding location (e.g., the GPS coordinates for the Museum of Natural History) on the first map, which may also include a plurality of representations of other media files.

In another example, a software application determines a respective score or rank (e.g., based on an aggregate rating by users who “Liked” or otherwise rated the media file, and/or a record of users who “shared” the item to their personal social networks or via email) for each of a set of media files (e.g., selected based on location of a user and in response to a search by the user). Those media files with higher rankings (e.g., the top ten ranked media files) for a given location are presented in order to the user via a graphic “gallery” interface, with the highest-ranked items presented first. In some embodiments, users can select the media files in the “gallery” view wherein each media file is represented by an image and/or via a “map” view that displays the specific locations of each file on an interactive map (e.g., via Google Maps).

In another example, those media files with higher rankings for a given map view may be represented differently on the map than the media files having the lower rankings (e.g., those outside the top ten). For instance, the associated location of an audio file ranked in the top ten may be marked by a “pin,” photo, icon or other visual representation that is different in prominence, indicia (e.g., rank numbers, letters), size, colored and/or shape, or otherwise different than the visual representation designated for media files having ranks between eleven and twenty, and different than the visual representation designated for media files outside of the top twenty. In this way, a user may easily ascertain which files of a plurality of mapped files are ranked highest for that user, and therefore which are more likely to be enjoyable for the user to watch or hear.

The method 700 may comprise receiving an indication of a request to modify the first map, at 710, and updating the interface to comprise the first representation of the first media file mapped to the first location on a second map having a second coverage area and to comprise a second representation of the second media file mapped to a second location on the second map, at 712. In some embodiments, a request to modify the map may comprise a GPS receiver and/or mobile application determining a change in the user's location. In some embodiments, the request to modify a map comprises input of a user (e.g., via a mobile device interface). In one example, when a user wishes to change a map view (e.g., by panning in a direction, by zooming the map view in or out), the resulting change in the represented geographic area may result in the presentation of a different set of geotagged media files and/or different representations being provided for one or more previously presented media files. For instance, in a first map view (e.g., zoomed out) a given audio file may not have a ranking high enough to represent as a primary or upper tier file (and in some embodiments may not be represented at all). If the user zooms in on the map (resulting in a smaller pool of media files available in the represented coverage area), however, that same audio file may, for example, move into the top ten ranked files represented in the new coverage area of the map. Accordingly, the software application may then represent the same file as a primary or upper tier file. Although only three types of classification are discussed in this example (e.g., a higher ranked tier of represented files, a middle ranked tier of indicated files and a lower ranked tier of files not represented in the map view at all) it will be understood that any number of allocations or classifications of the ranked files may be utilized, as deemed practical for a particular implementation. In some embodiments, numbered icons may be utilized in a map view to indicate a number of media items associated with the same particular location (e.g., “10,000” to represent the number of items associated with New York City in a zoomed-out view of the East Coast of the U.S., a “20” to represent the number of items associated with the Empire State Building in a zoomed-in view of Manhattan).

### F. Example Interfaces and Applications

Any or all of methods 400 (FIG. 4), 500 (FIG. 5), 600 (FIGS. 6) and 700 (FIG. 7), described above, and other methods described in this disclosure, may involve one or more interface(s), and the methods may include, in some embodiments, providing an interface via which a user may (i) search for, browse, play and/or record one or more types of media files and (ii) be presented with a map including representations of media files mapped at their respective geographic locations. Although examples and embodiments may be described with respect to audio files, it will be understood that other types of media files, including video, text and images, are contemplated by the Applicants and that example interfaces and applications may be modified as desirable for use with additional or alternative types of media files.

Although certain types of information are illustrated in a particular example interface, those skilled in the art will understand that the interface may be modified in order to provide for additional types of information and/or to remove some of the illustrated types of information, as deemed desirable for a particular implementation.

Although the example interfaces discussed are illustrated as different interfaces, those skilled in the art will readily understand, in light of the present disclosure, that the features and information of two or more interfaces, or a subset of such features and information, may be included in a single interface, screen display or application window.

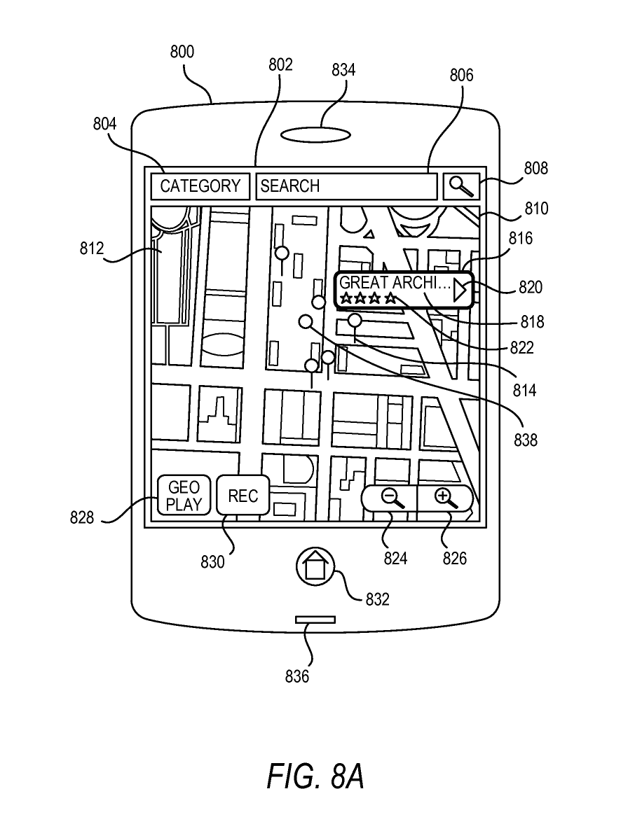

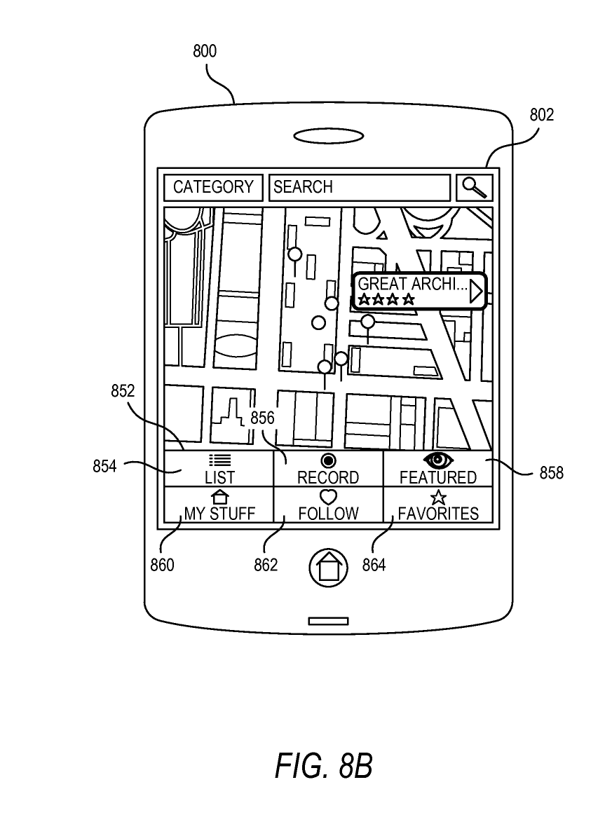

FIG. 8A illustrates an example interface 800 that may be embodied as a mobile device (e.g., a smartphone having a touch screen display). The example interface 800 comprises a graphical user interface 802 including an category selection button 804, a search text box 806, a search button 808, a map interface 810, a button 832 (e.g., a “home” button), a speaker 834 and a microphone 836 (e.g., for use in recording audio by a user). In one example, clicking the category selection button 804 reveals a list of possible categories for searching, allowing the user to select one or more categories in which to search. The user may also be able to search all categories.

In some embodiments the example interface 800 may include at least one camera device (not shown). In some embodiments, one or more of the elements or objects of the graphical user interface may be presented via a touch-sensitive display and may be actuated and/or selected by a stylus or a user's finger.

The map interface 810 includes a map 812, icons 814 representing primary (e.g., higher ranked) audio files, and icons 838 representing secondary audio files. The coverage area of map 812 may be adjusted, for example, by a user scrolling the map, tapping the map, using appropriate hardware buttons of the mobile device or soft buttons of the graphical user interface 802, to change or re-size the area depicted in the map 812. The icons 814 and 838 are selectable and/or clickable using an appropriate input device (e.g., a pointer device, a touch-sensitive display). Selecting one of the icons may reveal a file information object 816 (e.g., a balloon), including a title of the audio file (e.g., “GREAT ARCHI . . . ”), an associated rating 822 of the file (e.g., four stars) and a play button 820 for playing the audio file.

The map interface 810 further includes zoom buttons 824 and 826 for zooming out or zooming in, respectively, the coverage area represented by map 812. The graphical user interface 802 and/or map interface 810 may include one or more of a Geoplay button 828 for initiating and/or terminating a Geoplay mode (as discussed in this disclosure) and/or a record button 830 for initiating the recording of an audio file by a user.

FIG. 8B illustrates a variation of example interface 800. In particular, the graphical user interface 802 provides for a graphical menu 852 of selectable application functions, including a list button 854, a record button 856, a featured button 858, a my stuff button 860, a follow button 862 and a favorites button 864. In one embodiment, a user may take an action (e.g., pressing a corresponding button or menu item) to have the graphical menu 852 displayed. Selecting list button 854 may initiate the providing of a listing of search results and/or may replace a map view of geotagged audio files with a listing of the audio files (e.g., ordered by ranking for the user, ordered by file rating, ordered by popularity). Selecting record button 856 may allow a user to record an audio or video file. Selecting featured button 858 may initiate the presenting to the user (via a map and/or list view) of audio files that have been identified as featured content. Selecting my stuff button 860 may initiate the presenting to the user of information associated with the user, such as, without limitation, the user's profile (e.g., including one or more content preferences of the user), other users who follow the user (e.g., who subscribe with a media file management system to receive new audio files posted by the user and/or to receive notifications that the user has posted a new audio file), users the user follows, a history of audio files the user has listened to and/or a listing of audio files the user has recorded and/or uploaded to a media file management system. Selecting follow button 862 may initiate functionality allowing a user to select one or more other users to follow. Selecting favorites button 864 may initiate display to the user of a listing of audio files that the user has indicated are his or her favorites.

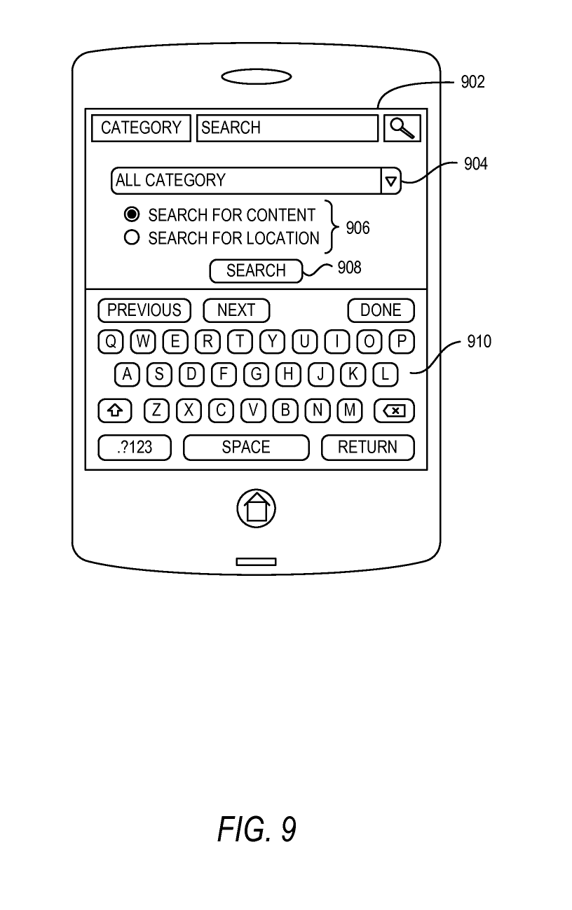

FIG. 9 illustrates an example graphical user interface 902 that may be embodied in a mobile device. The example graphical user interface 902 comprises a more detailed search interface, including a search category menu 904, selection options to search by content or by location 906 and a graphical keyboard 910 for inputting search terms and other text.

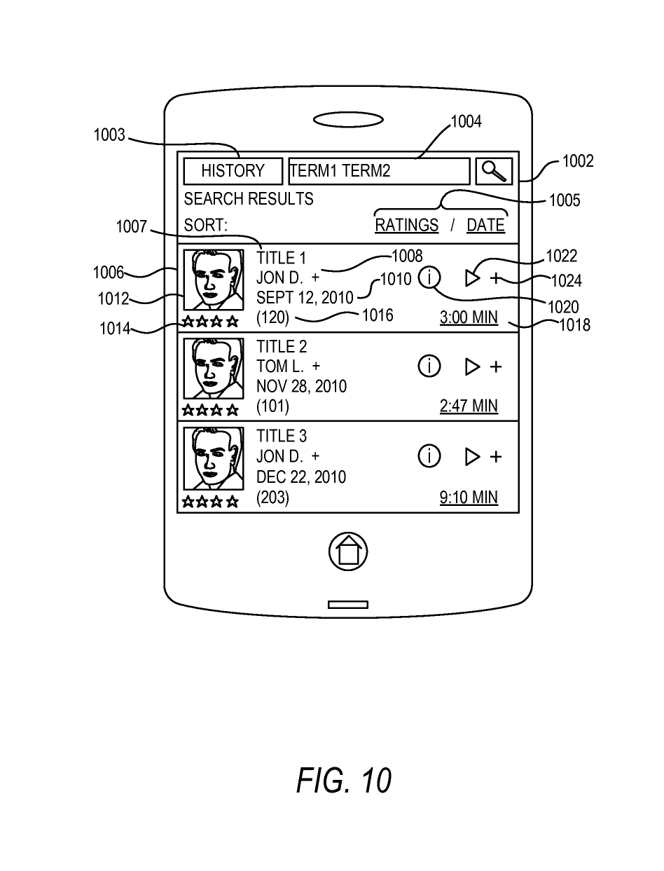

FIG. 10 illustrates an example graphical user interface 1002 that may be embodied in a mobile device. The example graphical user interface 1002 comprises a category selection button 1003 and a search text box 1004. In the example a category of “HISTORY” has been selected and search terms “TERM1 TERM2” have been entered (e.g., using a graphical or hardware keyboard, or voice input functionality of a mobile device).

The example graphical user interface 1002 also includes a listing of audio files 1006 for audio files meeting user-specified criteria. The listing may be sorted using sort criteria 1005 for sorting by rating or creation date of the audio files.

Each listed audio file 1006 is represented by a title 1007, an author of the 1008 audio file (which may be clickable to receive a listing of audio files by the author), an add (“+”) button to follow the author 1008, a date 1010 the audio was recorded, an image 1012 associated with the author and/or audio file, a rating 1014 associated with the file (e.g., may be clickable for the user to input a rating), a number of times 1016 the audio file has been rated, a length (duration) 1018 of the audio file, a more information button 1020 for accessing additional information about the audio file, a play button 1022 for playing the audio button and an add (“+”) button 1024 for adding the audio file to a user's playlist and/or list of favorite audio files.

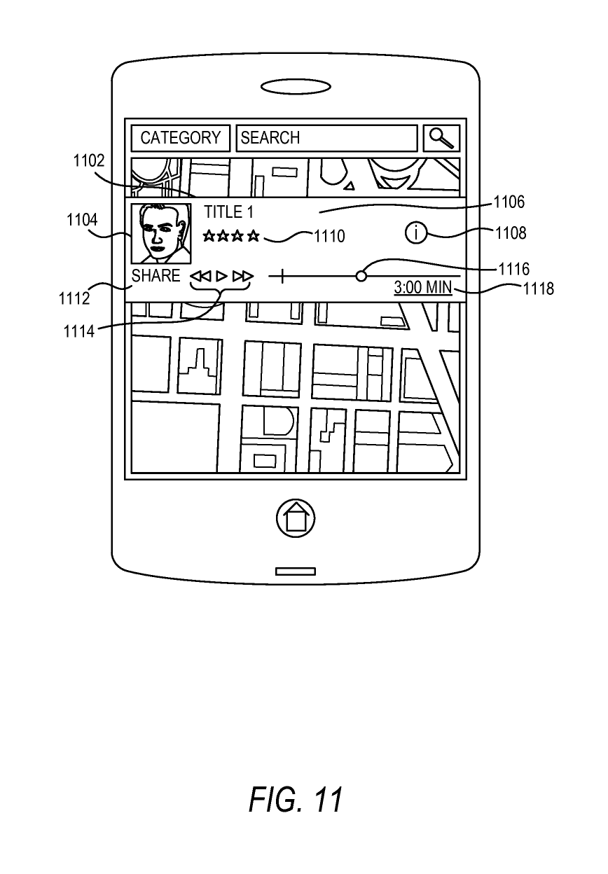

FIG. 11 illustrates an example graphical user interface 1102 that may be embodied in a mobile device and may be useful in representing a media player (e.g., currently playing or queued to play a particular media file). The graphical user interface 1102 includes an image 1104 associated with an audio file and/or an author of the audio file, a title 1106 of the audio file, a more information button 1108, a rating 1110, a share button 1112 for sharing the audio file with one or more users or recipients (e.g., by forwarding the audio file and/or a link to the audio file) and a length (duration) 1118 of the audio file. Clicking on the image 1104 and/or title 1106 may center a map interface on the location of the audio file and/or may open a pane providing additional information about the audio file.

The graphical user interface 1102 also includes an audio player including control buttons 1114 for skipping forward, skipping backward, playing and pausing an audio file and a navigation slider 1116 for moving play forward and backward in the file.

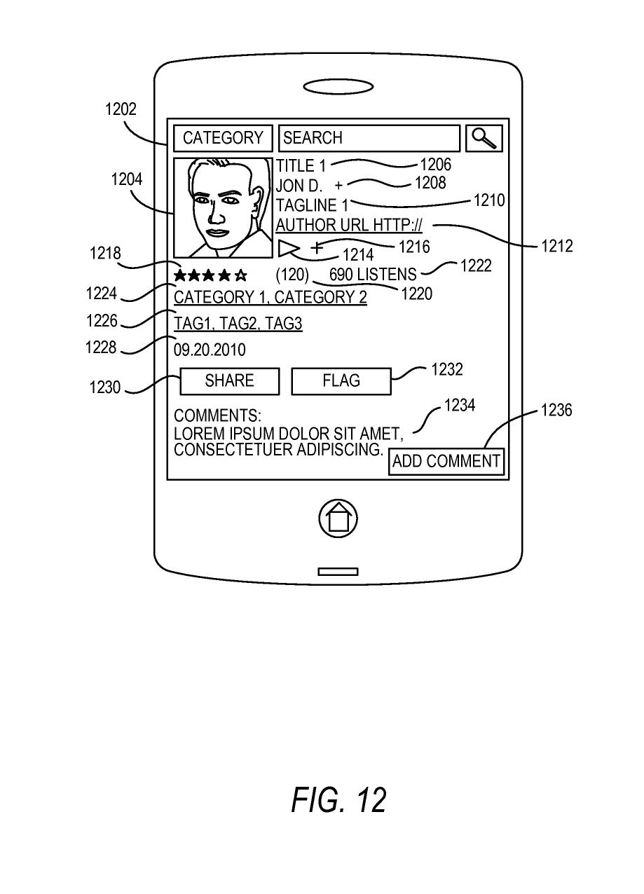

FIG. 12 illustrates an example graphical user interface 1202 for presenting, to a user, information about an audio file, including an image 1204 associated with the audio file and/or an author 1208 of the audio file, a title 1206 of the audio file, a description 1210 (e.g., a tagline) of the audio file, a URL 1212 associated with the author and/or the audio file, a play button 1214, a follow button 1216, a rating 1218 (e.g., that may be clickable for a user to input his or her rating, such as a “Like”, “thumbs up” or “thumbs down”, of the audio file), a number of ratings of the audio files 1220 by users, a number of times users have listened 1222 to the audio file, one or more categories 1224 associated with the audio file, one or more tags or keywords 1226 associated with the audio file, a creation or upload date 1228 of the audio file, a share button 1230 for sharing the audio file with one or more other users or recipients, a flag button 1232 for indicating that the audio file is or may be inappropriate (e.g., contains offensive language), a comments list 1234 including one or more comments or responses to the audio file provided by users and an add comment button 1236 for adding a comment to the indicated audio file.

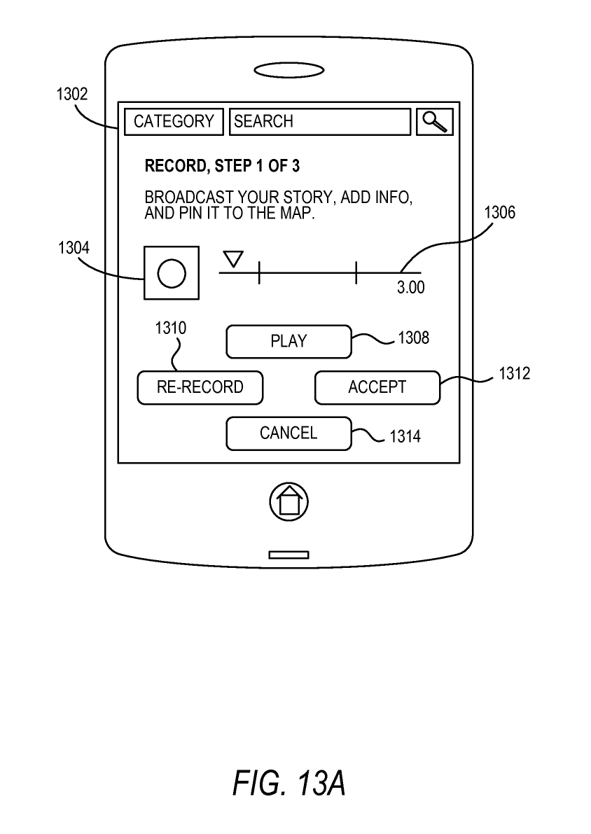

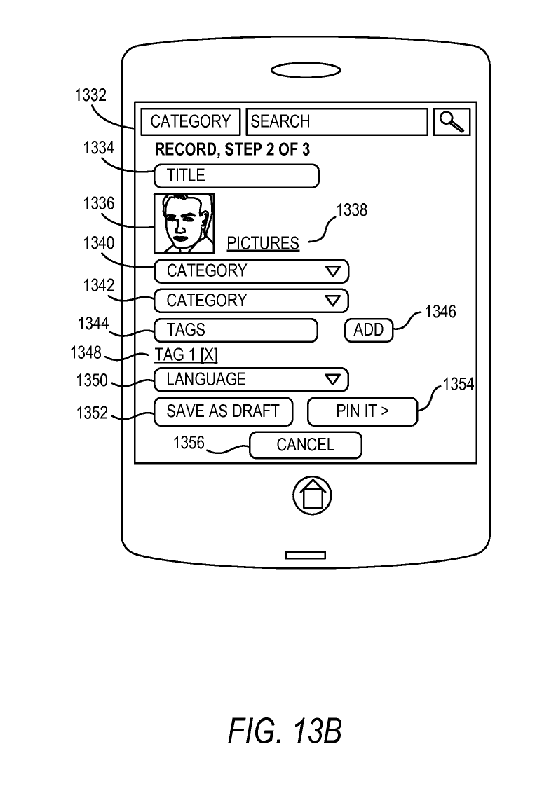

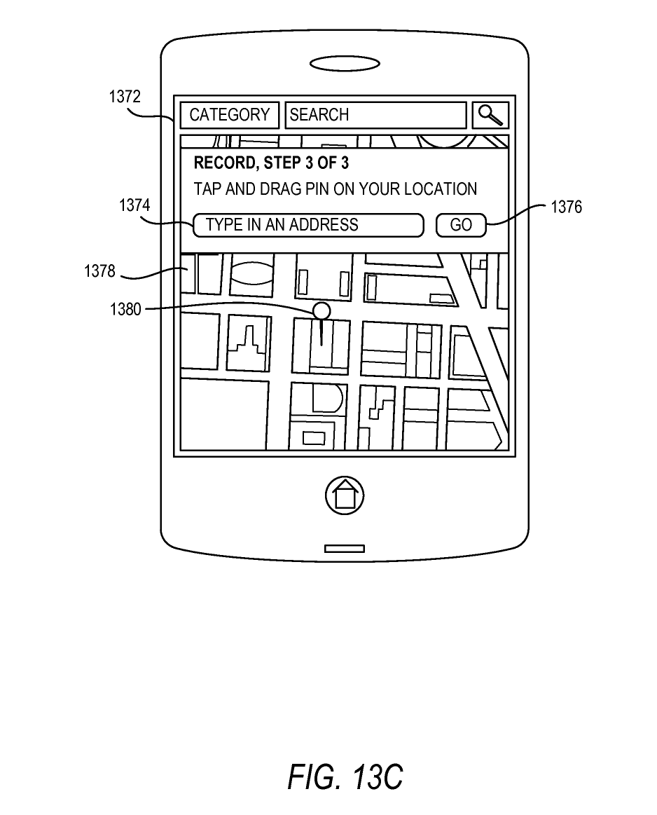

FIG. 13A, FIG. 13B and FIG. 13C illustrate example graphical user interfaces 1302, 1332 and 1372, respectively, that may be useful in facilitating a user's recording, describing and geotagging of an audio file. Example recording interface 1302 of FIG. 13A includes a record button 1304 for initiating recording of an audio file by a user (e.g., via a microphone of a mobile device), a navigation slider 1306 and play button 1308 for navigating and for playing back a recorded audio file (e.g., to review before saving the audio file or uploading it to a media file management system), a re-record button 1310 to erase a previously recorded audio file and replace it with a new recorded audio file, an accept button 1312 to save a recorded audio file and/or upload it to a media file management system (and, e.g., proceed to an editing interface for providing additional information about the audio file) and a cancel button 1314 for exiting the recording interface without saving or uploading a recorded audio file.

Example editing interface 1332 of FIG. 13B includes various fields and elements useful for providing additional information about an audio file recorded by a user, including a title field 1334 for entering a title of the audio file, an image 1336 associated with the audio file and an images button 1338 for selecting, replacing or deleting one or more images 1336, a first category button 1340 and a second category button 1342 for selecting categories to associate with the audio file, a tags input field 1344 for inputting a tag or keyword associated with the audio file, an add tag button 1346 for entering a new tag input in tags field 1344, one or more tags 1348 (e.g., which may include clickable links for removing the tag and/or for determining a list of media files sharing the same tag), a language selection button 1350 for selecting a language to associate with the audio file (e.g., the language spoken in the audio file), a draft button 1352 for saving the audio file without geotagging it, a geotag button 1354 for saving the audio file and initiating a process to geotag the audio file and a cancel button 1356 for exiting without saving any changes.

Example geotagging interface 1372 of FIG. 13C provides for a variety of ways to geotag an audio file. An address field 1374 allows a user to input a geographical location to associate with an audio file, and a button 1376 geotags the file to the indication location (e.g., saves the geographical information in the audio file and/or in a database such as media file data 294) and/or initiates a search for the indicated location (e.g., to identify the GPS coordinates of the desired location). Geotagging interface 1372 also includes a map 1378 allowing a user to create (e.g., by tapping) and drag an icon 1380 (e.g., via a touch-sensitive display) to a desired location on the map. The location of the icon on the map is then associated with the audio file. In one embodiment, the current location of the user device may be presented as a default location when geotagging a media file. In some embodiments, a geotag may comprise a predetermined location (e.g., “Brooklyn Bridge”) provided by a geotagging service, such as via the Foursquare™ API. In some embodiments, the geotag for a given media file may be changed, replaced or deleted at any time.

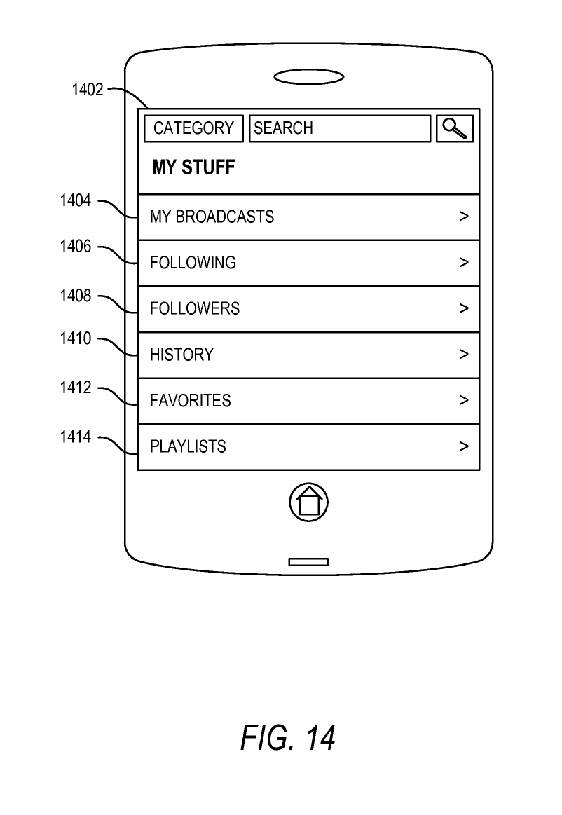

FIG. 14 illustrates an example graphical user interface 1402 for presenting, to a user, information associated with that user, including an element 1404 for presenting a list of audio files created by the user, an element 1406 for presenting a list of other users the user is following, an element 1408 for presenting a list of other users who are following the user, an element 1410 for presenting a list of audio files the user has listened to, an element 1412 for presenting a list of audio files the user has indicated are favorites of the user and an element 1414 for presenting to the user a list of playlists created by and/or saved by the user.

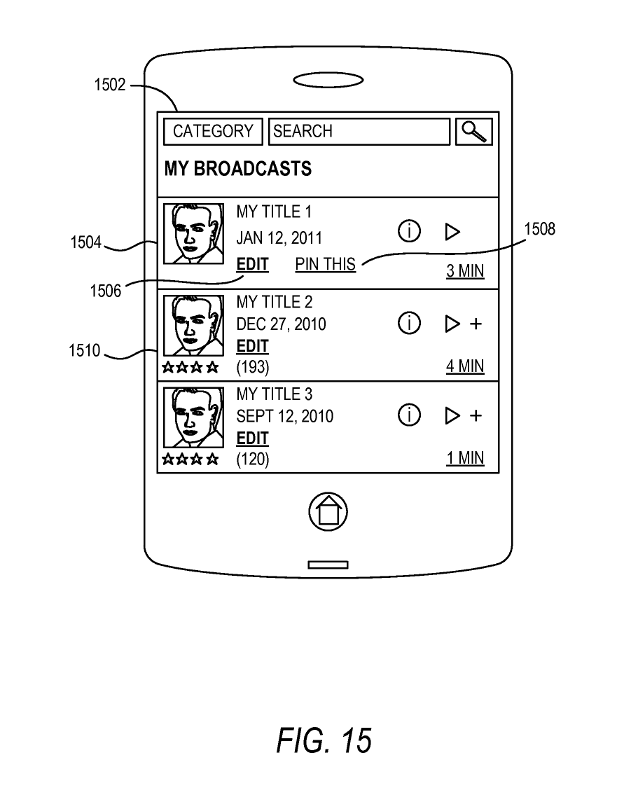

FIG. 15 illustrates an example graphical user interface 1502 for presenting, to a user, information associated with audio files recorded by and/or uploaded by that user. Interface element 1504 represents a draft audio file recorded by a user but not yet geotagged or pinned to a map, and the geotag button 1508 allows the user to begin the geotagging process. Edit button 1506 allows the user to edit various kinds of information associated with the audio file, as discussed in this disclosure and with respect to FIG. 13B. Element 1510 represents an audio file of the user that has been geotagged (although the associated geographical information may be changed, replaced or deleted in accordance with some embodiments).

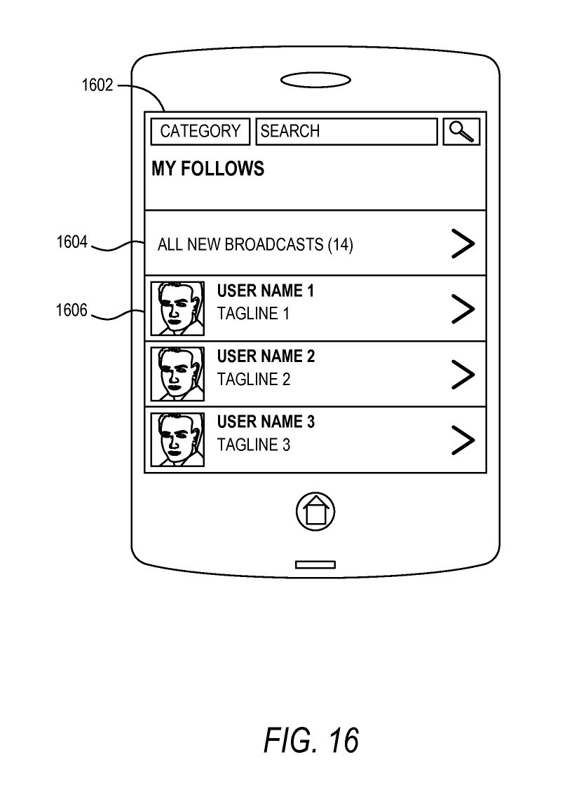

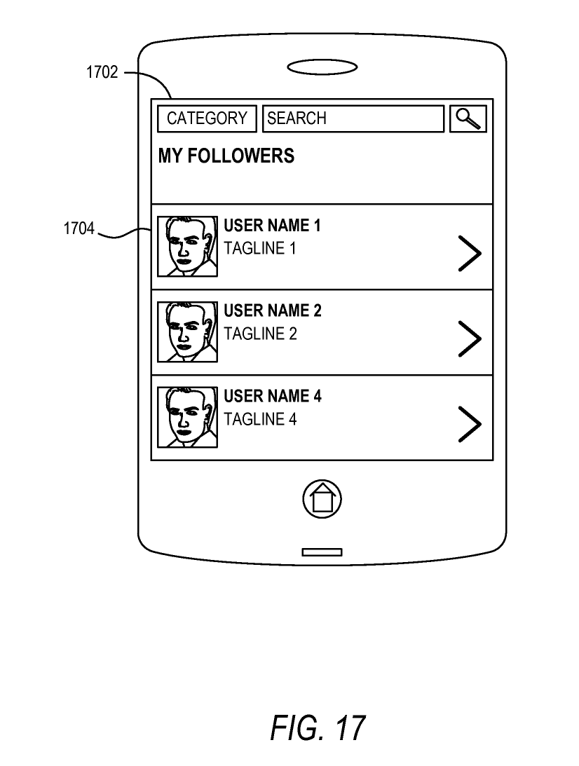

FIG. 16 illustrates an example graphical user interface 1602 for presenting, to a user, information about other users the user is following. Interface element 1604 initiates providing the user with a listing of new media files by other users the user is following. Interface elements 1606 provide some information about the other users the user is following. Clicking the element 1606 may initiate a search for audio files of that other user and/or initiate presenting of additional information about the other user. Similarly, FIG. 17 illustrates an example graphical user interface 1702 for presenting, to a user, information about other users that are following the user. Interface elements 1704 provide some information about the other users. Clicking the element 1704 may initiate a search for audio files of that other user and/or initiate presenting of additional information about the other user.

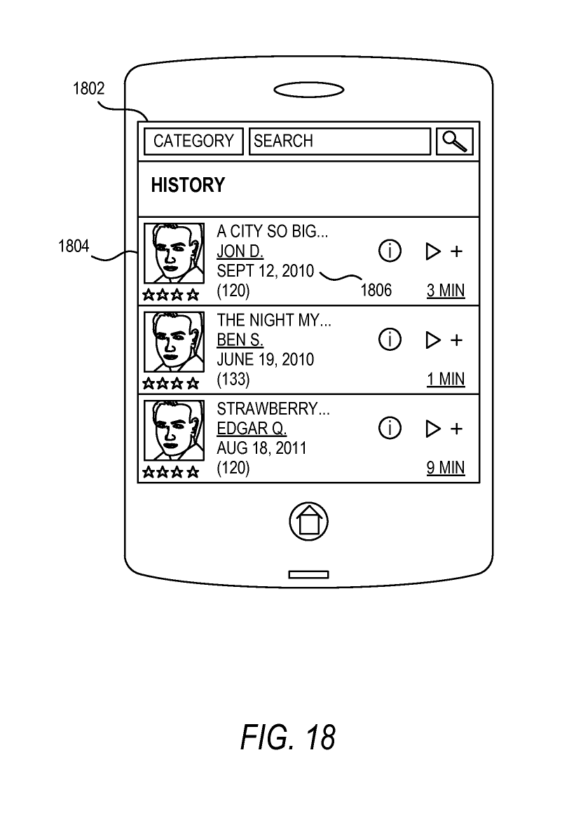

FIG. 18 illustrates an example graphical user interface 1802 for presenting, to a user, information about audio files 1804 the user has listened to (e.g., for all time, last month, last week, last thirty listens).

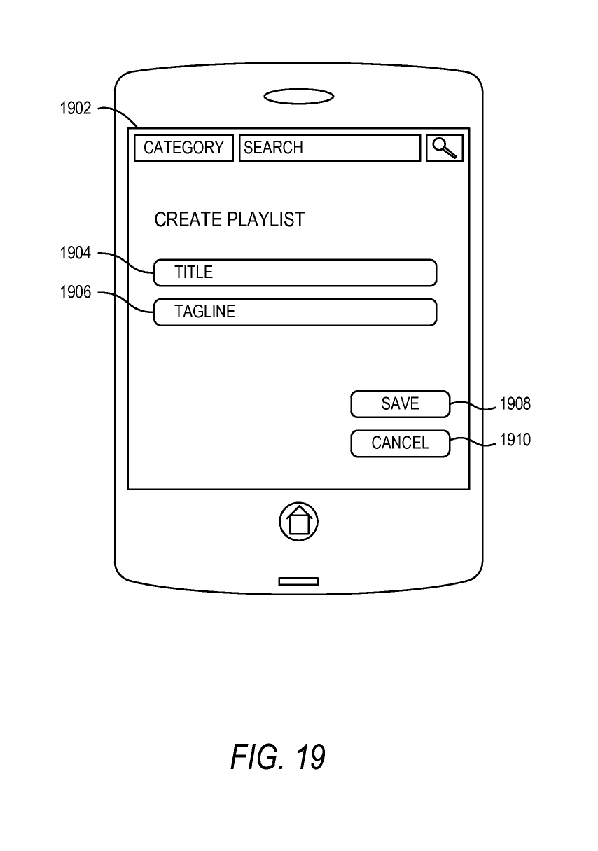

FIG. 19 illustrates an example graphical user interface 1902 for creating a playlist of audio and/or video files. Title field 1904 allows a user to input a title, and description field 1906 allows a user to input a description or tagline for the playlist. Save button 1908 allows the user to save a new playlist or make changes to an old playlist, and cancel button 1910 allows the user to exit the interface without saving changes.

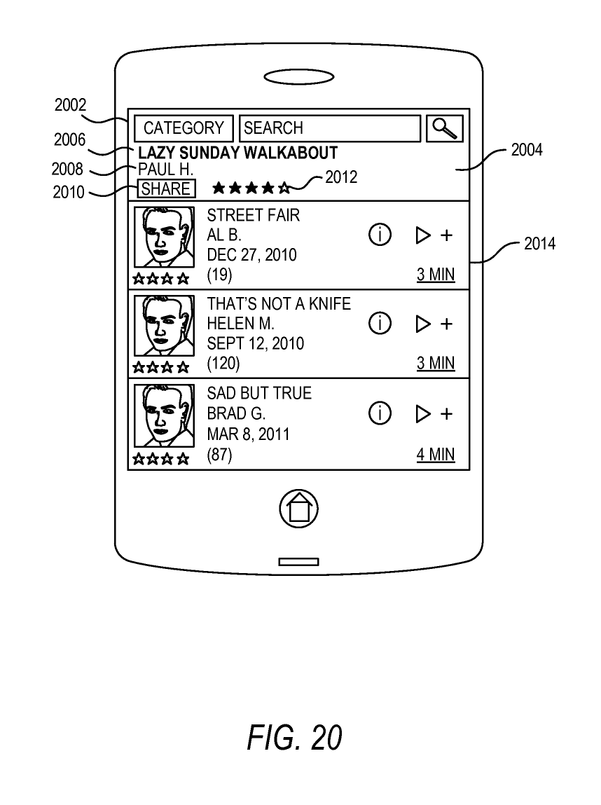

FIG. 20 illustrates an example graphical user interface 2002 for presenting, to a user, information about a playlist (which may have been created by the user, by another user, by the owner of a content platform or by a content provider). Playlist information area 2004 displays some information about a particular playlist. Title 2006 provides a title for the playlist and author 2008 identifies the user that created the playlist. Share button 2010 allows a user to share the playlist with one or more other users or recipients, and rating element 2012 allows the user to rate the playlist. Audio item 2014 provides information about one of the audio files included in the playlist.

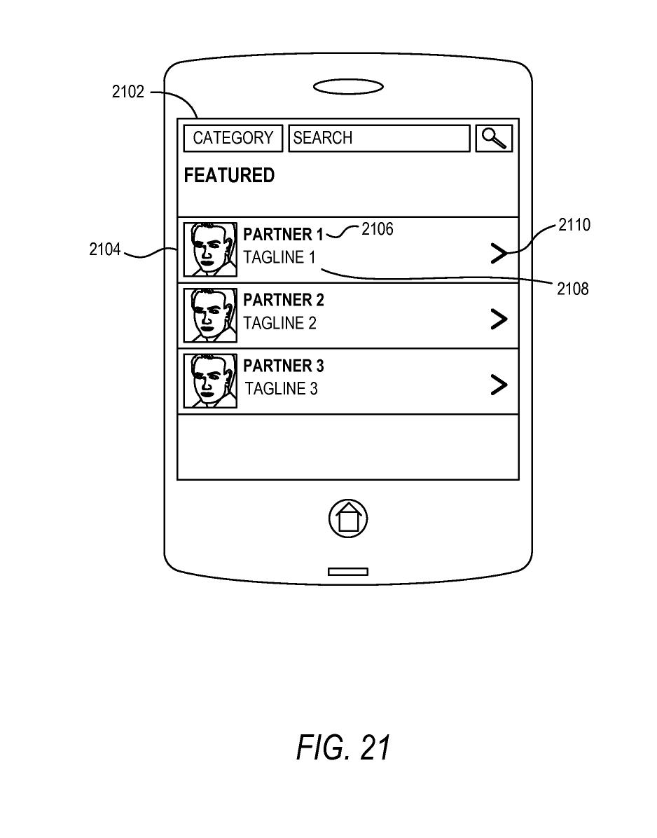

FIG. 21 illustrates an example graphical user interface 2102 for presenting, to a user, information about content being featured by a media file management system. Element 2104 provides some information about a partner or featured user 2106, including a description or tagline 2108 for that user (e.g., a user partnering with a media file management system to provide media files to the system). Element 2110 is clickable and initiates a search or other determining of a list of playlists and/or audio files of the partner or featured user 2106.

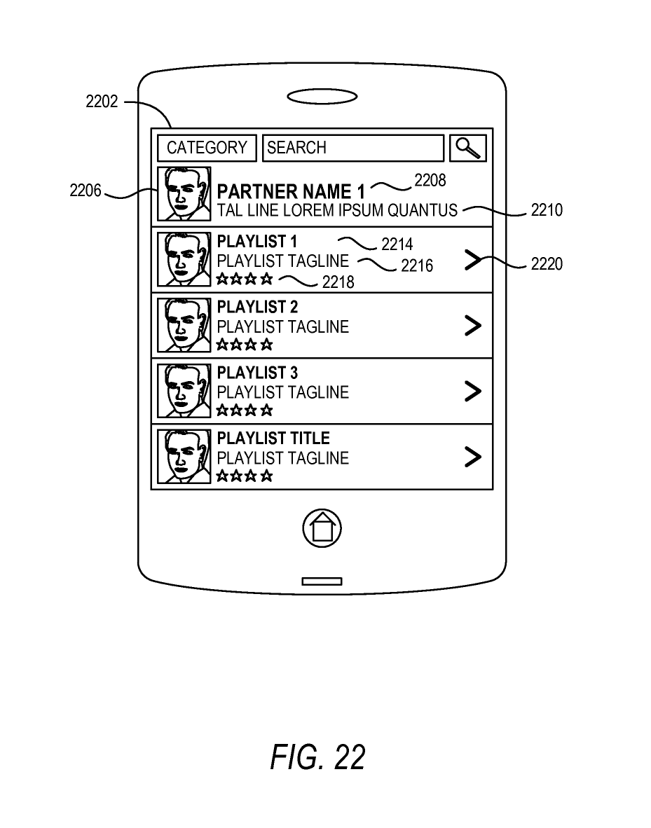

FIG. 22 illustrates an example graphical user interface 2202 for presenting, to a user, one or more audio files and/or playlists of another user (e.g., a content partner, featured user or regular user). Element 2206 provides some information about a partner or featured user 2208, including a description or tagline 2110 for that user (e.g., a user partnering with a media file management system to provide media files to the system). Title 2214 provides a title of an example playlist and description 2216 provides a description or tagline for the playlist. Rating 2218 provides an indication of a rating for the playlist. Element 2220 is clickable and initiates a search or other determining of a list of audio files associated with the particular playlist 2214 (e.g., as may be presented via interface 2002 of FIG. 20).

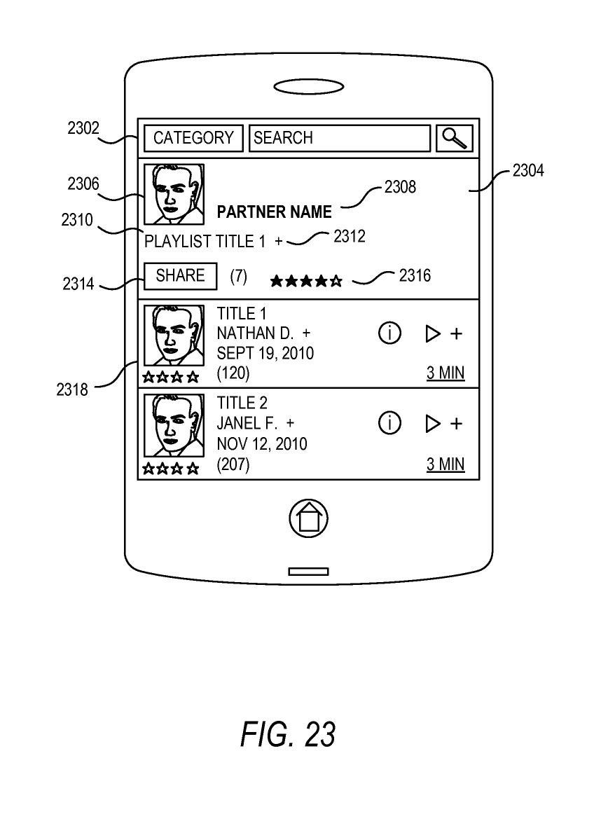

FIG. 23 illustrates an example graphical user interface 2302 for presenting, to a user, information about a playlist. Information pane 2304 provides information about the playlist, including playlist creator 2308 (e.g., a user, a content provider or partner), playlist title 2310, an add (“+”) button 2312 for adding the playlist to a user's saved playlists, a share button 2314 for sharing the playlist with one or more other users and/or recipients, and a rating element 2316 for presenting an aggregate rating and/or for allowing the user to indicate his or her rating for the playlist. Element 2318 provides information about a particular audio item in the playlist, as discussed with respect to various other example interfaces.

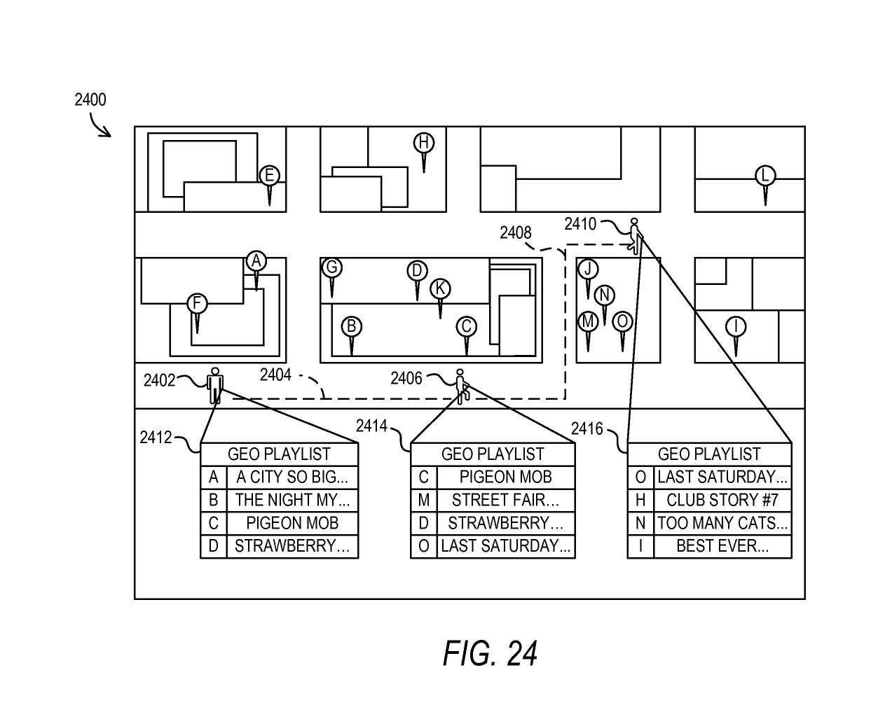

FIG. 24 illustrates a representation 2400 of a non-limiting example of a user receiving dynamically updated, localized playlists of audio files, via a mobile device (e.g., embodying and/or in communication with a media file management system), based on the user's current location. According to the example, a user begins at location 2402, depicted as a city street scene. The user is running an application on his smart phone or other mobile device that allows him, via a media file management system, to receive information about audio files relevant to his location (or to any location input by the user), as discussed with respect to various embodiments in this disclosure. For example, the audio files may be geotagged with GPS coordinates near his current location 2402. The user is running the application in an example Geoplay mode, as discussed above. As discussed in this disclosure, the user may enter one or more search terms, categories and/or keywords to initiate a search. In response to a search and/or the user's location, the user is served a playlist 2412 that includes audio files A, B, C and D, which have geotags near his location. In one embodiment, the first ranked audio file begins playing on the user's mobile device automatically when the playlist 2412 is received and/or determined; alternatively, the user may initiate play of the playlist.

In this example, audio file F is not included on the playlist 2412 even though it is the closest to location 2402. As discussed in this disclosure, this may be, for example, because the media file management system determined that audio file F ranked much lower for this user than the ranks determined for other audio files in the area (e.g., based on search criteria provided by the user, on information stored or determined by the system about the user's preferences and/or suggestions of a recommendation engine for the user).

Continuing with the example, the user continues along path 2404 to location 2406, while the mobile application plays through audio files A and B and begins to play audio file C from the playlist 2412. At location 2406, the mobile application generates a playlist 2414 (in the manner discussed above) that includes audio files C (currently playing), M, D and O. Audio files A and B are not selected for the new playlist 2414 (assuming they would have qualified otherwise) because, in accordance with one embodiment, they were played already. Audio file M, which did not appear in playlist 2412, is ranked higher in playlist 2414 than audio file D, which was included in the previous playlist 2412 (e.g., because audio file M is associated with a category that the user typically prefers more than a category associated with audio file D).

The user continues along path 2408 to location 2410, while the mobile application plays through audio files C, M and D and begins to play audio file O from the playlist 2414. At location 2410, the mobile application generates a third playlist 2416 (in the manner discussed above) that includes audio files O (currently playing), H, N and I. Audio file J is not ranked on the playlist 2416, despite its proximity to location 2410, and audio file H is included in playlist 2416 despite its relatively greater distance from location 2410. Various reasons for why an audio file may be recommended and/or ranked over another are discussed in this disclosure.

As discussed in this disclosure, the ranking or otherwise determining media files to make available for playback may be based on a speed, acceleration and/or direction of the user. In one example, a user in a car driving through a city may receive playback of the most relevant media items pulled from a relatively larger radius (e.g., 1 mile). In contrast, a user walking through the same city may be playing back items pulled from a more limited radius (e.g., 500 feet). In either example, the appropriate radius may be dynamically updated based on the amount of available local content, as discussed in this disclosure.

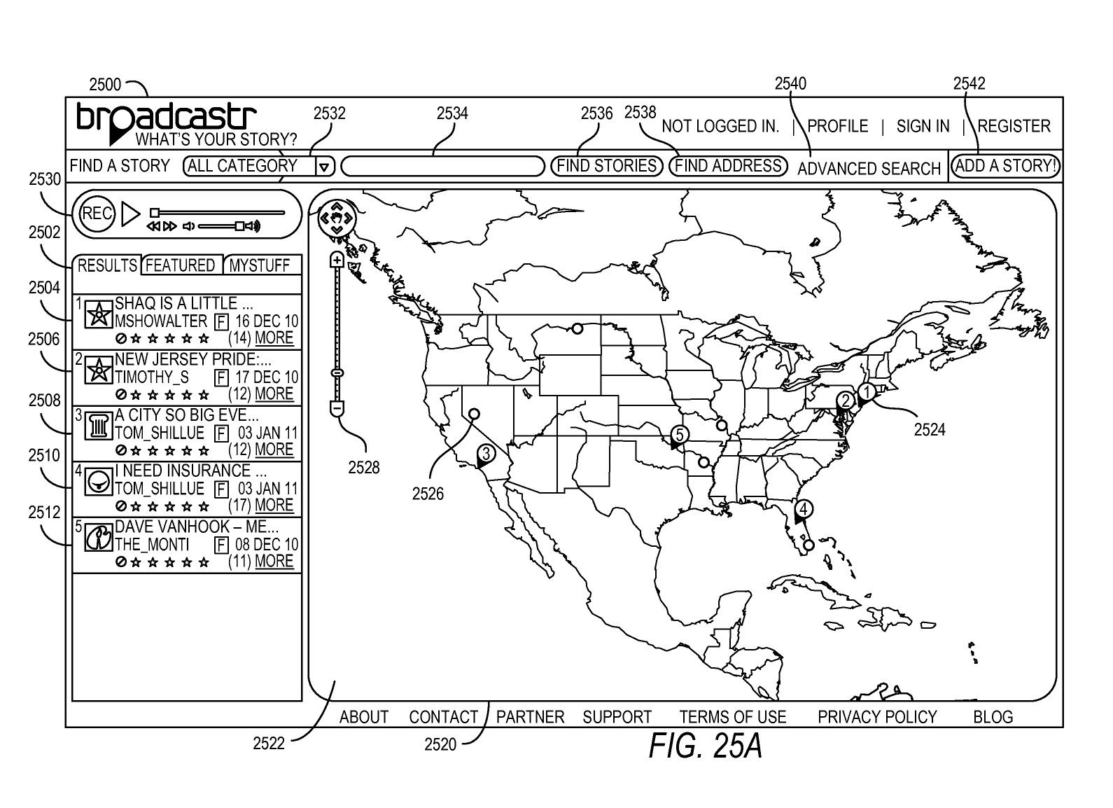

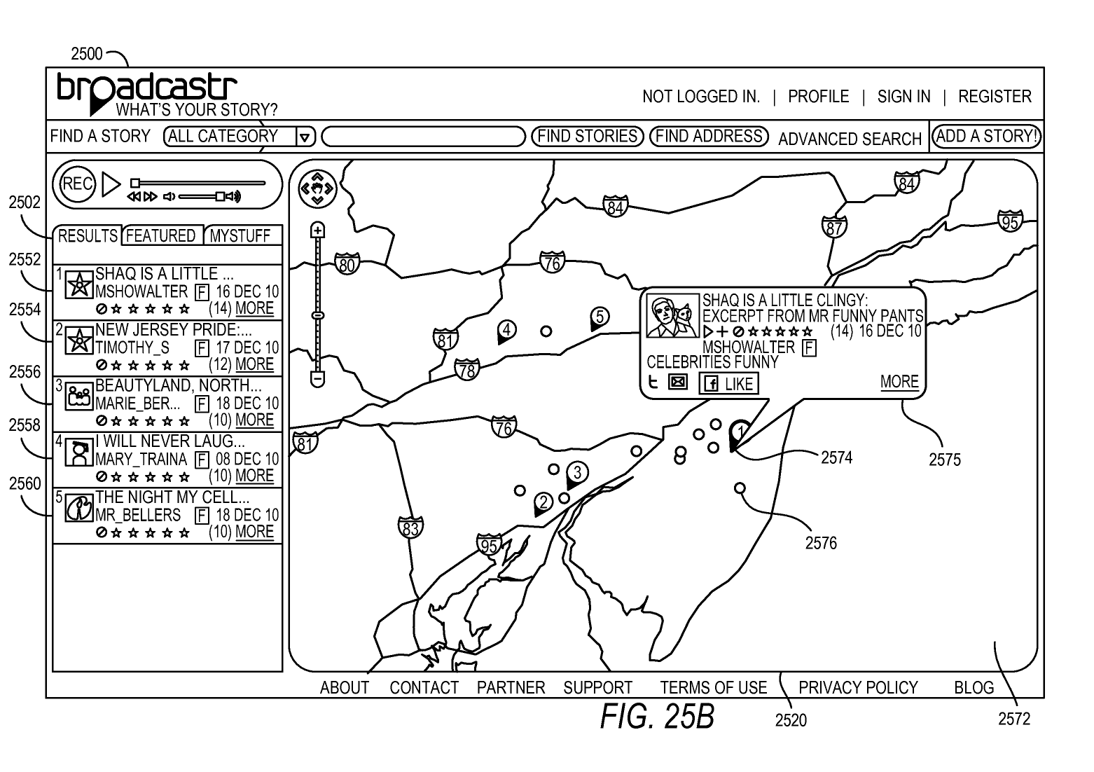

FIG. 25A illustrates an example graphical user interface 2500 for, among other things, presenting search and/or recommendation results to a user of a media file management system and allowing playback and recording of audio files. Results pane 2502 includes audio items 2504, 2506, 2508, 2510 and 2512 returned from a search and/or analysis of available audio files. Map pane 2520 includes a map 2522, primary map icons 2524 (for representing the locations of higher ranked audio files, such as those included in results pane 2502) and secondary map icons 2526 (for representing the locations of lower ranked audio files) and map controls 2528. Audio player 2530 includes controls for recording, playing and navigating an audio file, and changing the volume. Category selection menu 2532 allows a user to select one or more categories to search for audio files. Search text box 2534 allows a user to input one or more search criteria for searching for audio files. Find stories button 2536 and find address button 2538 allow a user to select to search for stories associated with the user's search criteria, or to search for audio files associated with a specified location, respectively. Advanced search button 2540 provides access to an advanced search interface. Recording button 2542 allows a user to begin recording, saving and geotagging an audio file.

FIG. 25B illustrates an example variation of graphical user interface 2500 as if, for example, a user had zoomed in on the map 2522 of FIG. 25A to focus on the area displayed in map 2572 of the map interface 2520. Results pane 2502 has been updated, based on the new map view, to display results 2552, 2554, 2556, 2558 and 2560. Map interface 2520 also includes primary map icons 2574 (for representing the locations of higher ranked audio files, such as those included in results pane 2502) and secondary map icons 2576 (for representing the locations of lower ranked audio files). Information pane 2575 includes information for the audio file represented by primary icon 2574.

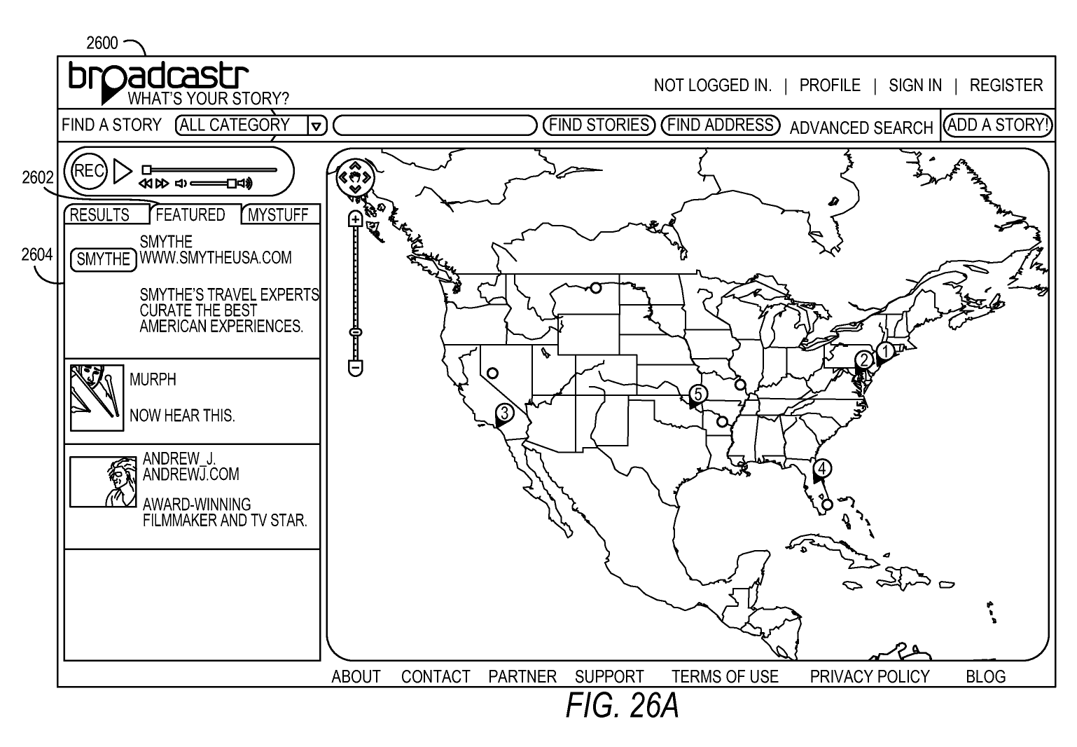

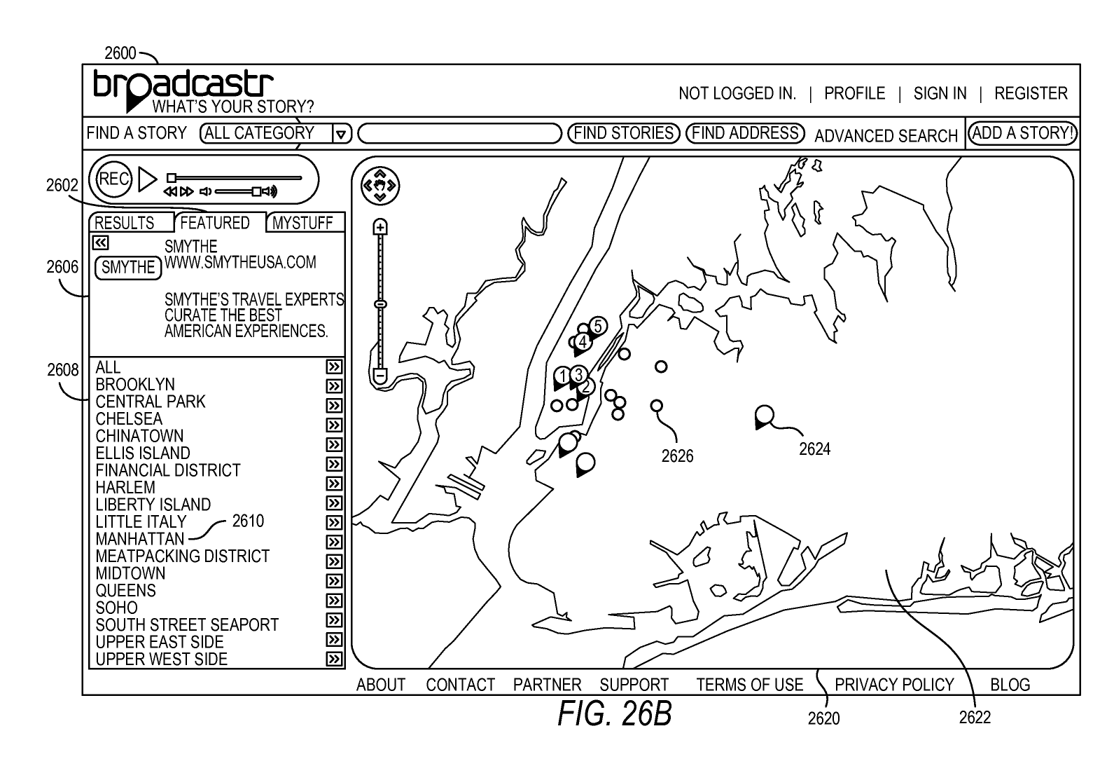

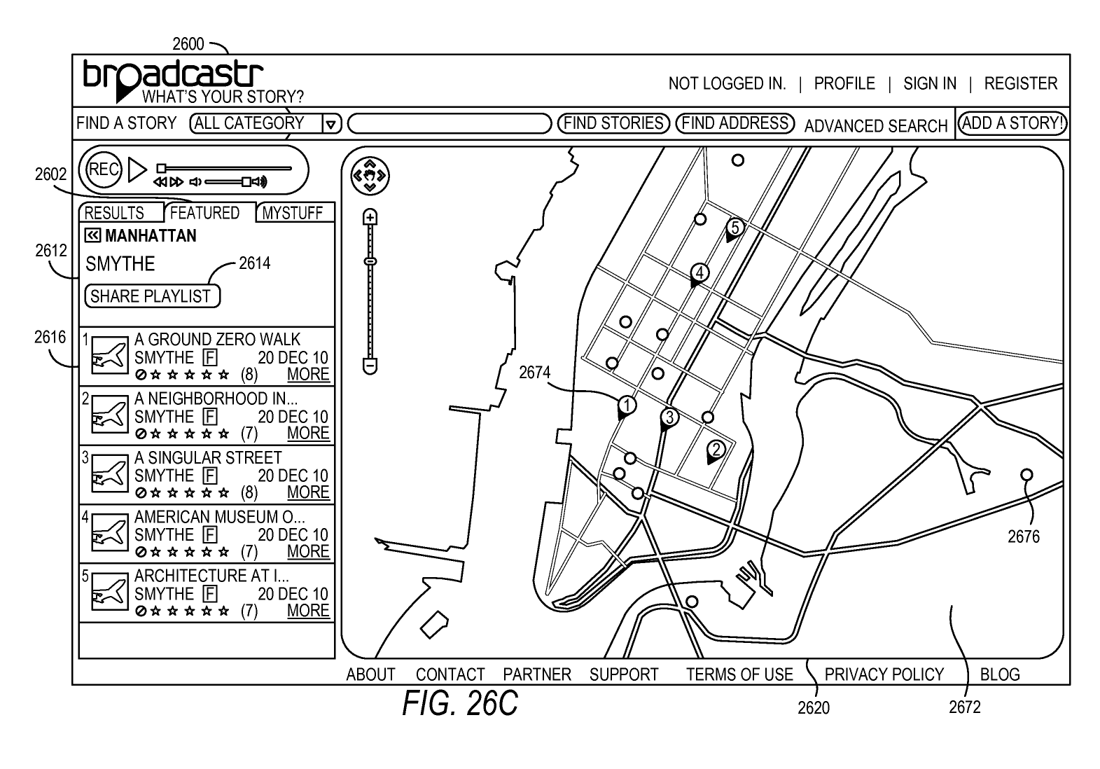

FIG. 26A illustrates an example graphical user interface 2600 including a user pane 2602. User element 2604 provides information about a particular user (e.g., a content partner) and is clickable to initiate a search for media files and/or playlists of the user.

FIG. 26B illustrates an example graphical user interface 2600 including a user pane 2602 representing information about a particular user 2606. User pane 2602 also includes a list of playlists 2608 of the user, including playlist 2610, which is clickable or otherwise selectable to initiate a search for the media files associated with the playlist 2610. Map interface 2620 includes a map 2622 having a coverage area configured to represent the geotagged locations of audio files related to the list of playlists 2608 of the user. In one example, when a user selects a particular user 2604 of FIG. 26A, the map interface 2620 is updated to feature audio files associated with the user 2604.

FIG. 26C illustrates another variation of graphical user interface 2600 including a user pane 2602 representing information about a particular playlist 2612 of a particular user. Share button 2614 allows a user to share the playlist with one or more other users and/or recipients. User pane 2602 also includes a list of audio files 2616 included in the playlist. Map interface 2620 includes a map 2672 having a coverage area configured to represent the geotagged locations of the audio files 2616 of the playlist 2612. In one example, when a user selects a particular playlist 2610 of FIG. 26B, the map interface 2620 is updated to feature the audio files included in the playlist 2610.

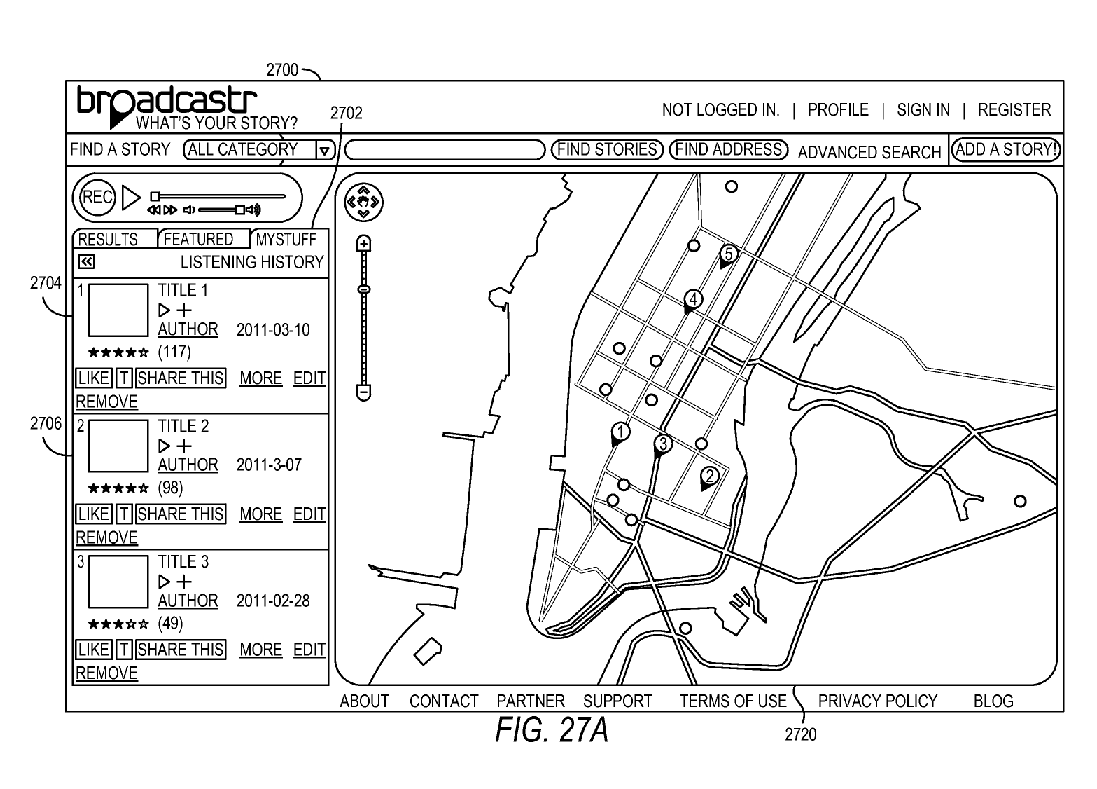

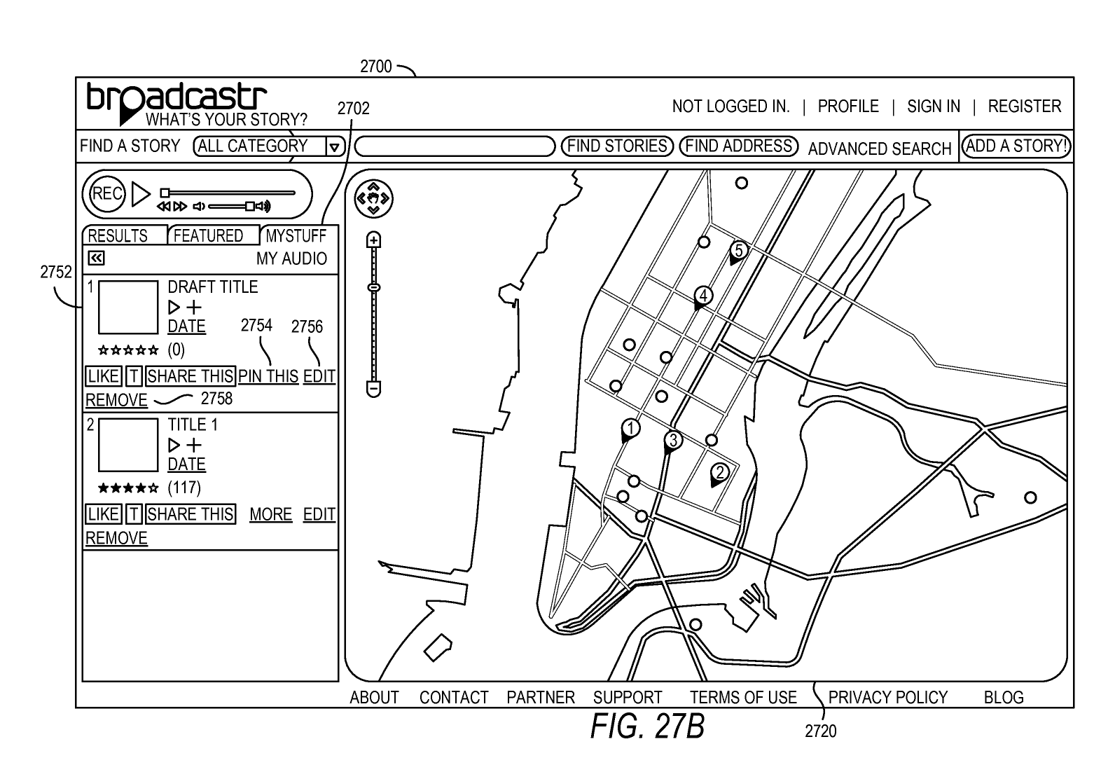

FIG. 27A illustrates an example graphical user interface 2700 including a map interface 2720 and a personal info pane 2702 displaying a list of audio files 2704 and 2706 that a user has listened to.

FIG. 27B illustrates an example graphical user interface 2700 including a map interface 2720 and a personal info pane 2702 displaying a list of audio files 2752 that a user has recorded and/or uploaded to a media file management system. Geotag button 2754 allows a user to initiate a process for geotagging the audio file 2752. Edit button 2754 allows a user to edit information (e.g., metadata) associated with the audio file 2752, and remove button 2758 allows a user to delete a saved audio file recorded and/or uploaded by the user.

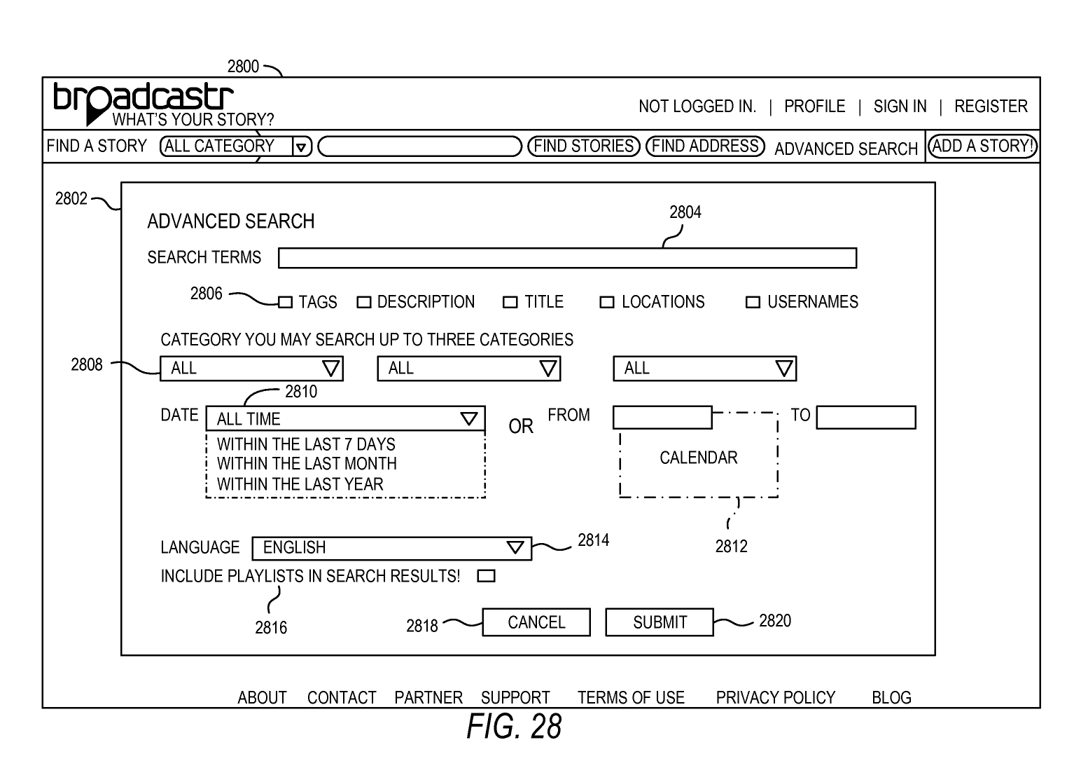

FIG. 28 illustrates an example graphical user interface 2800 allowing a user to input criteria for an advanced search of media files. Advanced search interface 2802 includes a search text box 2804 for inputting one or more search terms, and search filters 2806 for designating a search of tags, descriptions, titles, locations and/or usernames associated with media files. Category selection menus 2808 allow a user to select one or more categories to search, and date fields 2810 and 2812 allow a user to filter the search by creation date of the media files. Language menu 2814 allows a user to select a language associated with the media files, and playlists filter 2816 allows a user to specify whether playlists are to be included in the search results. Cancel button 2818 allows a user to cancel the search, and submit button 2820 allows a user to initiate the search using the detailed criteria.

According to an example application in accordance with one or more embodiments described in this disclosure, a platform is provided for creating, sharing and listening to user-generated audio stories with location information. The system, referred to herein as “Broadcastr,” comprises three major components: server, desktop client and mobile clients.

In one example implementation, the server side component of the Broadcastr platform preferably runs on the GOOGLE APP ENGINE framework (GAE) by Google and is hosted by the GOOGLE APPSPOT application hosting service by Google. The database is based on a datastore built upon the non-relational database (e.g., BIGTABLE). The database stores audio, video, text and image items in one or more various types of media formats (e.g., MP3, MP4, MOV, AVI, PNG, JPEG, SFW, FLV) together with metadata, including a geolocation associated with them. Searching is supported by custom indices, which allow efficient retrieval of media items based on location, filters and metadata, sorted by date and/or user-generated rating.

The client components in the Broadcastr system preferably display a dynamic map populated with pins (or other icons) corresponding to audio items. Geolocation support is implemented through a map application (e.g., via GOOGLE MAPS API). The map can be panned and zoomed, and it populates the visible area of the map with audio items that have a highest cumulative rating. Users can view information about all items and play them by clicking or touching the pin. Users can also relocate their own items by dragging or holding the respective pin.

Client components preferably allow searching for media items based on specific criteria and playing all items associated with a specific map segment or map view. Users can create their own playlists, can filter by language or category, can follow other users and share audio items via popular social networking sites such as TWITTER and FACEBOOK. Users can record their own stories, attach suitable metadata, upload them to the server and pin them to a specific location.

The desktop client in the example Broadcastr system is web-based and is built on dynamic HTML (e.g., using a development toolkit such as GOOGLE WEB TOOLKIT (GWT)). Recording and playing of items may be implemented via a framework such as FLEX by ADOBE, and a web browser plugin such as FLASH PLAYER by ADOBE. In another example, playback may be facilitated via a framework such as HTML5. Multimedia maps and items can be embedded as an HTML snippet in another web page. Embedded items may be displayed as an image on a map and/or in a gallery view of relevant items and can be played, for example, by the user selecting the item using an input device (e.g., a touchscreen, a pointer device).

The mobile clients in the example Broadcastr system may be implemented, for example, as native for various device operating systems, such as iOS for APPLE′S IPHONE and IPAD, and the ANDROID OS by GOOGLE. The LAME open-source library may be used for MP3 encoding of recorded items. When recording an item, users can take a picture using a device's camera and associate it with an audio or video story.

The mobile applications preferably also support two modes of playing: AutoPlay and Geoplay. In AutoPlay mode, a playlist of media items can be manually constructed by a user, or automatically generated based on the user's criteria, language, filters and/or system recommendations. The playlist is displayed as images on a map or in a browse (gallery) view and when the map is manually moved by the user, or the user's location changes, a new playlist is generated. Items already consumed may be taken into account and not included in the playlist. In Geoplay mode, the GPS antenna of the mobile device is used to determine the current location of the user. The media items (e.g., audio, text, image and/or video files), based on the user's criteria, language, filters and/or system recommendations, are ordered according to their proximity to the user's location and/or according to their respective cumulative ratings. As a user moves together with the mobile device, the playlist is refreshed and reordered to take into account the new location of the user. Items already consumed may be taken into account and not included in the playlist.

### ADDITIONAL EMBODIMENTS

Although some of the examples provided in this disclosure may be discussed in the context of mobile devices (e.g., cell phones, smartphones, net computers, tablet computers, heads-up display (HUD) glasses, other HUD devices) and communications systems for mobile devices, according to one or more embodiments, media files may be determined, transmitted and/or recommended for a user, via various different types of computing devices.

According to some embodiments, determining at least one media file to present, offer and/or display to a user may comprise determining one or more of: (i) one or more categories associated with media files that the user most frequently listens to or otherwise accesses, downloads, searches for and/or reviews and/or (ii) one or more media files to which the user has given higher ratings. Alternatively, or in addition, some embodiments provide for determining a second user who has similarly rated at least one of the same media files as a first user. Based on the apparent similarity in the likes and/or dislikes of the first and second users, a media file management system may provide for recommending to the first user at least one media file liked by the second user and/or not recommending to the first user at least one media file not well liked by the second user. In one example, the system may recommend to a first user a media file the first user has not watched, listened to, etc., based on a second user liking the media file, where the first user and the second user appear to have similar taste (e.g., based on their respective ratings of the same and/or similar media files). In another example, if two users rate a predetermined number media files (e.g., twenty-five) within a predetermined scoring range (e.g., within one point where rating is on a five-point scale), the two users may be considered comparable for the purposes of recommending media files to one or both of the users. Various other types of recommendations systems or engines are discussed in this disclosure.

According to some embodiments, users and/or content providers may create curated experiences, such as a museum tour, historical walk, or an outdoor, interactive adventure. In such cases, users may be able opt-in to the guided experience. In some embodiments, the order of playback of various media files (e.g., of a playlist) may be determined by a user's location, movement and/or playback history (e.g., the order in which they have consumed content).

According to some embodiments, media items and/or the locations of such items may be presented to a user visually as a visual, augmented reality overlay to “real world” images viewed through a camera interface (e.g., an integrated smartphone camera). In some embodiments, the existence of a media file may be revealed in this manner only and/or playback may be available only if the user “unlocks” the content in this manner.

### INTERPRETATION

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features is required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “memory device,” “computer-readable memory” and “tangible media” specifically exclude signals, waves, and wave forms or other intangible or transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What we claim is:

1. A method, comprising:
determining, via a server computer in communication with a plurality of user devices, a preference associated with a user;
determining, via the server computer, a plurality of available media files;
determining a first location of a user device associated with the user;
determining, via the server computer, a first playlist of media files based on the plurality of available media files, the preference, the first location, a respective ranking of each media file, and a respective associated location for each media file;
initiating play of a media file of the first playlist on the user device;
determining a second location of the user device that is different than the first location;
determining, via the server computer, a second playlist of media files based on the plurality of available media files, the preference, the second location, the respective ranking of each media file, and the respective associated location for each media file; and
initiating play of a media file of the second playlist on the user device.

2. The method of claim 1, in which determining the preference associated with a user comprises:
identifying at least one media file previously consumed by the user.

3. The method of claim 1, in which determining the preference associated with a user comprises:
determining a preference of the user for a category of media file.

4. The method of claim 1, in which determining the preference associated with a user comprises:
determining a preference of the user based on at least one ranking of a media file by the user.

5. The method of claim 1, in which determining the preference associated with a user comprises:
determining a preference of the user based on at least one sharing of a media file by the user.

6. The method of claim 1, in which determining the plurality of available media files comprises:
determining, via the server computer, at least one media file that is associated with at least one condition specified by a contributor of the at least one media file;
determining that the at least one condition is satisfied; and
unlocking playback of the at least one media file for the user.

7. The method of claim 1, in which determining the plurality of available media files comprises:
determining, via the server computer, at least one media file that is associated with a predetermined geographical radius for enabling playback, in which playback is not available to users outside of the predetermined geographical radius;
determining that the first location is within the predetermined geographical radius; and
determining that the at least one media file is available to the user.

8. The method of claim 1, in which determining the plurality of available media files comprises:
determining, via the server computer, at least one media file that is associated with a predetermined period of time for enabling playback, in which playback is not available to users outside of the predetermined period of time;
determining that a current time is within the predetermined period of time; and
determining that the at least one media file is available to the user.

9. The method of claim 1, further comprising:
determining a respective ranking for at least one of the available media files.

10. The method of claim 9, in which determining the respective ranking for at least one of the available media files comprises at least one of:
ranking the at least one available media file based on a preference of the user for a category of media file,
ranking the at least one available media file based on at least one rating of a media file by the user,
ranking the at least one available media file based on a rating of the at least one available media file by at least one other user,
ranking the at least one available media file based on sharing of at least one media file by the user,
ranking the at least one available media file based on a respective popularity of the at least one available media file, and
ranking the at least one available media file based on at least one media file previously consumed by the user.

11. The method of claim 9, in which determining the respective ranking for at least one of the available media files comprises:
ranking the at least one available media file based on a speed of the user.

12. The method of claim 9, in which determining the respective ranking for at least one of the available media files comprises:
ranking the at least one available media file based on a direction of travel of the user.

13. The method of claim 9, in which determining the respective ranking for at least one of the available media files comprises:
ranking the at least one available media file based on a geographic orientation of the user.

14. The method of claim 9, further comprising:
receiving, by the server computer, an indication of an amount of ambient light detected at the user device; and
in which determining the respective ranking for at least one of the available media files comprises:
ranking the at least one available media file based on the indicated amount of ambient light.

15. The method of claim 1, further comprising:
determining the first location based on a GPS location of the user device.

16. The method of claim 1, in which initiating play of the media file of the first playlist comprises:
initiating play of the media file of the first playlist at the user device automatically without input from the user.

17. The method of claim 1, in which initiating play of the media file of the first playlist comprises:
transmitting, by the server computer to the user device, at least one of the media files of the first playlist.

18. The method of claim 1, in which initiating play of the media file of the first playlist comprises:
transmitting, by the server computer to the user device, a representation of the first playlist.

19. The method of claim 1, further comprising:
determining a direction of travel of the user; and
in which determining the second playlist of media files comprises:
removing from the first playlist at least one media file that, based on the direction of travel, is behind the user.

20. The method of claim 1, further comprising:
determining a speed of the user;
determining a geographical radius based on the speed; and
in which determining the first playlist of media files comprises:
determining the first playlist of media files based on the plurality of available media files, the preference, the first location, the respective ranking of each media file, the respective associated location for each media file, and the geographical radius.

21. An apparatus comprising:
a processor; and
a computer-readable memory in communication with the processor, the computer-readable memory storing instructions that when executed by the processor result in:
determining a preference associated with a user;
determining a plurality of available media files;
determining a first location of a user device associated with the user;
determining a first playlist of media files based on the plurality of available media files, the preference, the first location, a respective ranking of each media file, and a respective associated location for each media file;
initiating play of a media file of the first playlist on the user device;
determining a second location of the user device that is different than the first location;
determining a second playlist of media files based on the plurality of available media files, the preference, the second location, the respective ranking of each media file, and the respective associated location for each media file; and
initiating play of a media file of the second playlist on the user device.

22. A computer-readable memory device storing instructions that when executed by a computer comprising at least one processor result in:
determining, via a server computer in communication with a plurality of user devices, a preference associated with a user;
determining, via the server computer, a plurality of available media files;
determining a first location of a user device associated with the user;
determining, via the server computer, a first playlist of media files based on the plurality of available media files, the preference, the first location, a respective ranking of each media file, and a respective associated location for each media file;
initiating play of a media file of the first playlist on the user device;
determining a second location of the user device that is different than the first location;
determining, via the server computer, a second playlist of media files based on the plurality of available media files, the preference, the second location, the respective ranking of each media file, and the respective associated location for each media file; and
initiating play of a media file of the second playlist on the user device.
